(19) United States
(12) Patent Application Publication
(10) Pub. No.: US 2003/0156624 A1
(43) Pub. Date: Aug. 21, 2003

(54) Signal transmission method with frequency and time spreading

(76) Inventor: Koslar, (US)

Correspondence Address: Stephen R. Whitt, 1215 Tottenham Court, Reston, VA, 20194, US

(21) Appl. No.: 10/067,793

(22) Filed: Feb. 8, 2002

(51) Int. Cl. H04B 1/69

(52) U.S. Cl. 375/131; 375/295

(57) ABSTRACT

A transmission system using frequency and time spreading techniques is disclosed. The transmission system allows priority of transmission parameters and adjustment of same in relation to transmission quality and channel characteristics measured in real time.

### BACKGROUND OF THE INVENTION

The invention relates to a spread spectrum transmission method for broadband transmissions, via wireless or hardwired connections, over a transmission channel subject to interference and multipath propagation.

The use of spreading methods for transmitting messages is well known. The symbols of a data stream with a defined code sequence (chip sequence, spreading code) to be transmitted are multiplied and subsequently transmitted using, for example, the Direct Sequence Spread Spectrum method (DSSS). The bandwidth of the message is increased as a result depending upon the number of chips in the code sequence. The message signal thus undergoes frequency spreading before transmission.

In the receiver, which knows the code sequence used by the transmitter for spreading, the frequency spread is removed by correlating the received signal with the code sequence. The frequency of the received signal is thus said to be “despread.”

The code sequence used by the transmitter and receiver for coding and decoding has a fixed time duration that corresponds to the duration of the symbols in the data source. The system is not able to respond to changes in the symbol data rate.

The transmitted signal may also undergo frequency spreading using the Frequency Hopping Spread Spectrum method (FHSS). In this method, individual data packets, controlled by a code sequence (hopping sequence) are transmitted consecutively in different frequency domains of a given message channel. Here too, the received message signal is despread in the receiver using the known hopping sequence.

A common feature in these two methods is the requirement of a transmission bandwidth for the transmitted message that corresponds to a fixed multiple of the baseband signal bandwidth. Because of this system requirement both the Direct Sequence method and the Frequency Hopping method are only able to use part of the available channel capacity in point-to-point connections. Thus, the symbol data rates which can be achieved are low in comparison with other transmission methods. Both methods are also inflexible and cannot adapt to a change in the received data, i.e. changes in the symbol rate and, in conjunction with this, the baseband signal bandwidth.

Better utilisation of channel capacity is achieved by use of these frequency-spreading techniques in multiple-access methods (for example DS-CDMA). Theoretically, the maximum data rates for a given channel bandwidth can also be achieved with the CDMA method by the parallel use of different code sequences for the individual subscriber stations and by the use of space division techniques. A prerequisite for this is a synchronisation at chip level. However, it has been shown in practice that the optimum values cannot be achieved.

Due to the low symbol rates, CDMA methods are comparatively insensitive to transmission interference caused by multipath propagation. Such methods are also advantageous in that they work with correlative selection methods, i.e. they separate channels by correlation on the time axis. As multipath propagation produces interference signals, which have different time references, not only are adjacent channels suppressed by the time-correlative methods but also the multipath signals.

If data is to be transmitted over available message channels at the highest possible data rates, and if at the same time the bandwidth resources are to be flexibly distributed, then it is necessary to resort to alternative access methods, such as TDMA methods that permit flexible management of individual channels and with which data rates up to the maximum possible physical data rate can be achieved by making optimum spectral use of the channel.

If, however, the data-transmission rate is increased for the given channel bandwidth, then the sensitivity to interference (distortion) due to multipath propagation also increases at the same time. If, when an information symbol is being transmitted via a message channel a delay spread of certain length is produced, then the number of subsequent symbols distorted by the reflections will be determined by the symbol rate. The higher the symbol rate, the more complex the distortions of the symbol stream become and the more difficult it is to compensate (or equalized) the multipath effects in the receiver.

All known methods of equalization require a very accurate determination of transmission channel parameters. The state of the art for determining such parameters is accomplished by means of a channel assessment (or channel measurement). The starting value for this assessment is the pulse response of the channel.

For measuring wireless channels, the state of the art, as described in German patent document DE 34 03 715 A1, includes the use of signals having good auto-correlative characteristics referred to hereafter as “correlation signals.” The desireable characteristics of a correlation signal include the auto-correlation of the signal, which by definition is a function of the time shift, having a pronounced maximum at a time shift of zero, whereas at all other time shifts, the auto-correlation has absolute values which are as small as possible. Clearly this means that the auto-correlation of the correlation signal represents a pulse which is as narrow as possible with little leading and trailing transient oscillation. Various families of correlation signals are known. Amongst others, the correlation signals include the often mentioned pseudo-noise (PN) sequences, which in practice are realised by means of time-discrete signal-processing. In order to ensure that the term is unambiguous, the subset of time-discrete correlation signals will be defined here as correlation sequences. M-sequences and Frank Zadoff Chu sequences should also be mentioned as further examples of correlation sequences.

The use of correlation sequences for transmitting information and for selecting channels in multipath access systems is known from CDMA technology (Direct Sequence CDMA). Here, not only are the auto-correlative characteristics of a sequence important but also the cross-correlative characteristics within a family of sequences. Within a family with good correlative characteristics, the cross-correlation between any two different sequences in this family has low absolute values compared with the maximum of the auto-correlation of each sequence in the family.

The use of chirp pulses for the measurement of certain channel characteristics in hardwired telephone channels is also described in communications technology. See for example, T. Kamitake: “Fast Start-up of an Echo Canceller in a 2-wire Full-duplex Modem”, IEEE proc. of ICC′84, pp 360-364, May 1984, Amsterdam, Holland.

Chirp signals, whose particular suitability for measuring purposes is known from radar technology, can likewise be interpreted as correlation signals and, when processed time-discretely, as correlation sequences. However, in contrast to the PN sequences normally used, chirp signals are complex and exhibit a multitude of phase states. Moreover, proposals exist, see for example U.S. Pat. No. 5,574,748, for using chirp signals for transmitting information via wireless and wired channels.

In summary, it can be said about the state of the art that, with the known methods for frequency spreading, the advantage of immunity to interference goes hand in hand with low symbol rates and with a low spectral efficiency. A flexible distribution of resources and a matching of the systems to changing symbol rates and to variable bandwidth requirements cannot be achieved with the existing methods.

### SUMMARY OF THE INVENTION

In order to transmit messages with high symbol rates at the same bandwidth, it is necessary to resort to other transmission techniques without frequency spreading, which do not have one important advantage of the spreading methods, i.e., the robustness against narrow-band interference. In any case, added to this is the sensitivity of the transmission to multipath propagation, which demands the use of equaliser circuits and, as a prerequisite for this, a very accurate determination of the channel characteristics.

It is therefore an object of the present invention to devise a multiple-access method for transmitting messages via channels with interference due to multipath propagation. The proposed method enables signals having high symbol rates to be transmitted and yet react flexibly and with maximum spectral efficiency to changes in the received data and to variable subscriber-related requirements for transmission speed and bit error rate.

In one aspect, the present invention solves the problems associated with conventional system by means of a method transmitting information symbols having a given symbol rate via a channel having a prescribed bandwidth, wherein the information symbols are subjected to frequency-spreading and time-spreading at the transmitter and a corresponding despreading at the receiver. The method according to the present invention allows an adaptive matching of a respective signal spreading and associated system gain to required transmission quality requirements and channel characteristics.

In one related aspect, the foregoing method controls system gain by a variations in the symbol rate. In another related aspect, the method allows adjustment in the frequency spread and/or the time spread in accordance with at least one of a set of parameters including transmitter power, bit error rate and/or transmission speed (bit rate).

In part, the present invention is predicated on a recognition that in a communications system transmitting information symbols sequentially both a frequency spreading by means of quasi Dirac pulse formation and a time spreading by interleaving the frequency-spread information symbol with a correlation signal must be carried out for each information signal. Thus, for every input-data rate, a maximum possible frequency spread, as determined by the bandwidth and the maximum time spread, can be reasonably be achieved. In effect, this leads to a minimum susceptibility to interference. Temporal overlap of the correlation signals, which often occurs at high data rates and leads to an inter-symbol interference, can be avoided in the present invention by a suitable choice of correlation signals, and/or with a correct selection of filter settings.

Furthermore, the same correlation signal (e.g. chirp signal) which is used in the present invention for transmission of a single information symbol is also used to measure the channel. This has the effect of greatly simplifying the structure of the receiver.

### BRIEF DESCRIPTION OF THE DRAWINGS

Presently preferred embodiments of the present invention are explained in more detail below in conjunction with the drawings, in which:

FIG. 1 is a block circuit diagram of a transmission system according to the present invention;

FIG. 2 is a block circuit diagram of an alternative embodiment of the transmission method according to the present invention;

FIG. 3 is a block circuit diagram illustrating another embodiment of the present invention;

FIG. 4 is a block circuit diagram showing a further variant of the present invention;

FIG. 5 is a block circuit diagram showing a sampling control in the receiver;

FIG. 6 is signal diagrams showing signals from the circuit shown in FIG. 3;

FIG. 7 is an exemplary program sequence for the assessment of a transmission channel;

FIG. 8 is an envelope curve for a compressed chirp pulse;

FIG. 9.1a is a graphical diagram illustrating signal-noise ratio as a function of channel data rate;

FIG. 9.1b illustrates signals at the output of a compression filter in an exemplary receiver;

FIG. 9.2a is a representation of transmission signals and related broadband interference;

FIG. 9.2b is a representation of a transmission signal spectra and related broadband interference;

FIG. 9.2c is a block circuit diagram showing additive superimposition of a transmission signal and interference in the form of a pulse;

FIG. 9.2d is a representation of signals having compressed chirp pulses and extended interference components;

FIGS. 9.3 through 9.8 illustrate exemplary program sequence for an access method according to the present invention;

FIG. 9.9 is a representation of a TDMA frame with several subscriber time slots having different widths;

FIG. 9.10a and 9.10b are representations of the TDMA frame with time slots of different width and schematic representation of the signal response after being compressed at the receiver;

FIG. 9.11 lists formulae for the calculation of peak amplitudes for signals compressed at the receiver in different time slots according to FIG. 9.10;

FIG. 9.12 illustrates the change of time slot data in relation to a change in system requirements (Compare FIG. 9.10);

FIG. 9.13 lists formulae for the calculation of peak amplitudes for signals compressed at the receiver in accordance with FIG. 9.12;

FIG. 9.14 illustrates the ends of the transmission signal envelope in accordance with FIG. 9.9.

### DESCRIPTION OF PREFERRED EMBODIMENTS

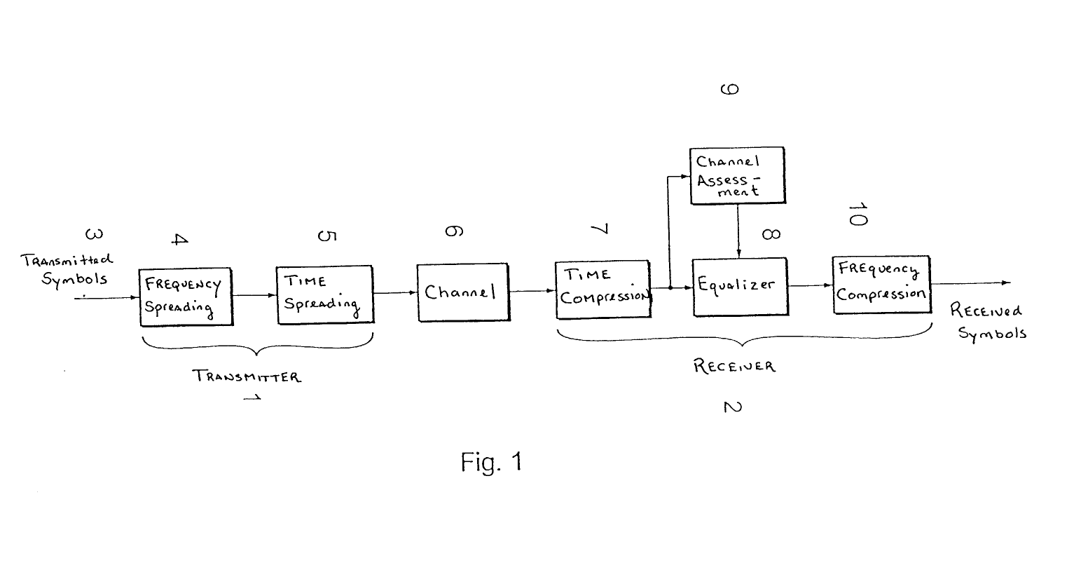

FIG. 1 shows a simplified block diagram for a transmission system according to the present invention. The information symbols to be transmitted 3 first undergo a frequency spreading 4. When the signal processing is continuous over time, this is carried out, for example, by conversion to pseudo Dirac pulses followed by band pass filtering. With time-discrete signal processing, the operation of “upsampling” (increasing the sample rate), for example, has the effect of spreading the frequency.

In the next step, the time-spreading 5 of the frequency-spread symbols takes place. (The frequency spreading 4 and time spreading 5 functions are preferably implemented in a transmitter 1). As an example, time spreading 5 occurs by interleaving with a correlation sequence. This is followed by transmission of the symbols via a channel 6. Any number of modulation stages, intermediate-frequency stages and high-frequency stages may be considered as part of the transmission channel 6. At the other end of transmission channel 6, the received signal along with superimposed interference now passes through a time compression stage 7. Time compression may be accomplished, for example, by interleaving the received signal with the time-inverted conjugated complex correlation sequence.

The symbols subsequently appearing enable a good assessment of the channel 9 to be made, which in turn allows conventional equalisers 8 to be used even for high symbol rates. Finally, frequency compression 10 takes place, which is realised, for example, by a sample-and-hold term or by an integrate-and-dump term. The time compression 7, channel assessment 9, equalization 8, and frequency compression 10 functions are preferably performed in a receiver 2.

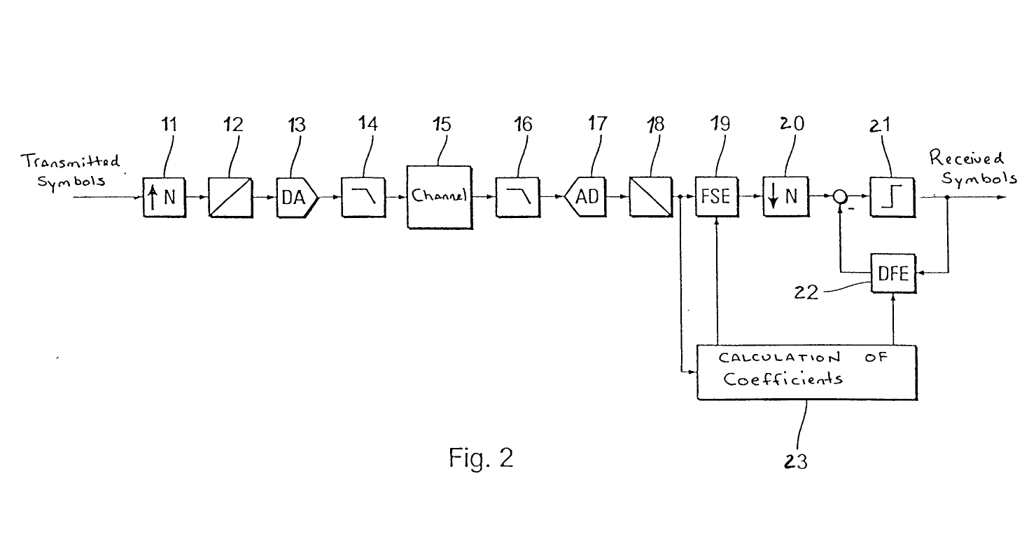

A more detailed embodiment of the present invention using digital and thus time-discrete signal-processing techniques is shown in FIG. 2. A sequence of transmission symbols, in which each element represents a complex number from a symbol alphabet, is applied with a symbol clock to the input of the arrangement. This sequence is up-clocked 11 by a factor of N. Up-clocking 11 may be accomplished by increasing the clock rate and inserting mathematical zeros (no information), which is equivalent to a spreading of the frequency.

The clocked-up sequence then passes through a transmission filter 12, whose pulse response correspends to the chosen correlation sequence. Physically, this means that each symbol initiates the complete correlation sequence multiplied by the symbol value. Mathematically, this is equivalent to interleaving the clocked-up sequence with the correlation sequence, during which a time-spreading of the individual symbol takes place.

The resulting signal then passes through a digital-analogue converter 13 and subsequently through a low-pass output filter 14.

This is followed by communication of the symbols via a transmission channel 15. In practice, transmission channel 15 comprises many separate transmission elements or media and may include amplifiers, mixing elements, as well as intermediate-frequency and high-frequency stages.

At the receiving end, the signal first passes through a low-pass input filter 16 and then an analogue-digital converter 17. The digitised signal is thereafter fed into a receiver filter 18, which has a conjugated complex frequency response compared with the transmission filter 12. As a result, time-compression takes place. For the case where a single reference symbol has been transmitted from the transmitter end, the channel pulse response directly appears at the output of receiver filter 18 without additional steps.

The coefficients of a distortion eliminator or equaliser can be calculated 23 immediately using known algorithms, such as, K. D. Kammayer: Nachrichtenubertragung (Message Transmission) 2nd edition, Stuttgart 1996. In the present example, a Fractional Spaced Equalizer, (FSE) 19, is used in combination with a Decision Feedback Equalizer, (DFE) 22. See further, S. Qureshi: Adaptive Equalization, IEEE Communications Magazine, Vol. 20, March 1982, pp 9-16.

As the signal passes through FSE 19, which represents a linear filter, signal distortion is compensated. The signal is subsequently clocked down 20 by a factor N. Clocking-down is a reduction in clock rate with only each nth value being passed on. After being clocked-down, the received symbol representation enters a decision stage 21 in which it a decision is made as to what symbol is present, the decision being made in relation to an agreed alphabet. The decision is fed back into DFE 22. By this means, further channel distortion of the signal is compensated.

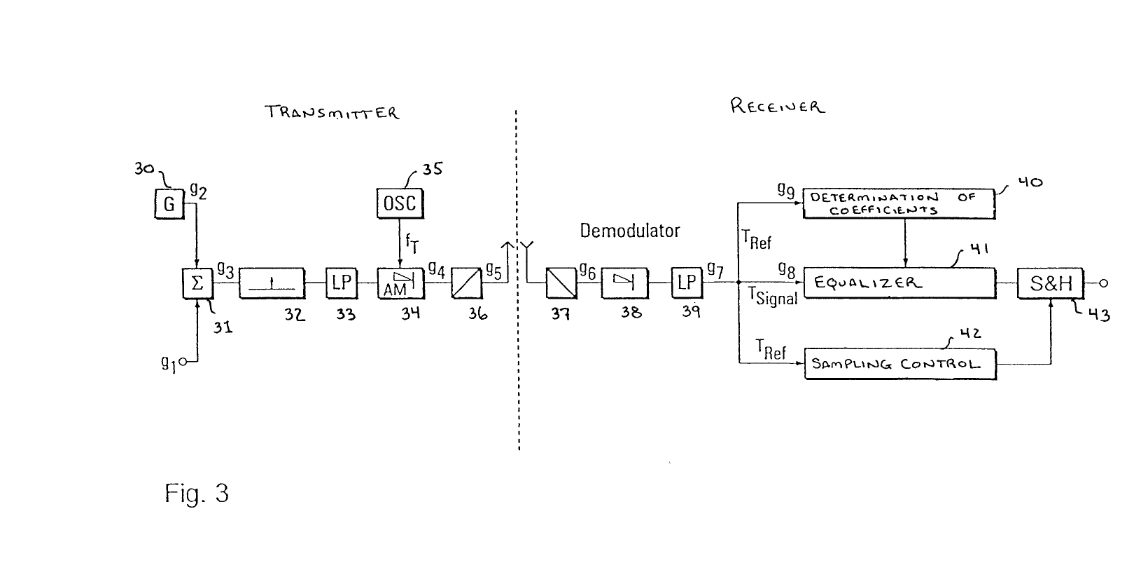

In a further embodiment shown in FIG. 3, reference symbols for assessing (or determining) channel characteristics are placed in front of the payload data packet being transmitted. These reference symbols consist of information symbols arranged in a special measuring interval. The reference symbols are transmitted to the receiver using a combination of frequency spreading and time spreading methods. Distortion of the reference symbols occurring in the measuring interval due to multipath propagation is recorded, analysed and directly used to determine coefficients for the equaliser.

In order to carry out measurement of the channel with the required high accuracy, the reference symbols must be transmitted with a high signal-to-noise ratio. Furthermore, the reference signals must have high resolution on the time axis in order to be able to determine accurately the phase position of the multipath components. Both requirements are met by the frequency spread and time spread transmission of the reference symbols.

In the example, a chirp pulse is used as the correlation sequence for the time spreading and for the compression in time of the symbols. Chirp pulses are linear frequency-modulated pulses of constant amplitude of duration T, during which the frequency continuously changes from a lower to an upper frequency by rising or falling linearly. The difference between the upper and the lower frequency represents the bandwidth B of the chirp pulse.

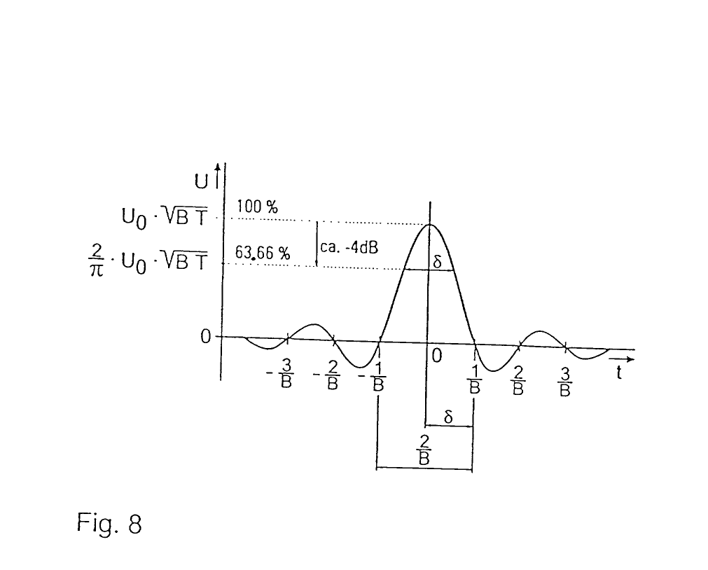

The total duration T of this pulse, multiplied by the pulse bandwidth B, is described as the extension or spreading factor φ, where φ=B·T. If such a chirp pulse passes through a filter with an appropriately matched frequency-duration characteristic, then a time-compressed pulse is produced with an envelope similar to sinx/x (See, FIG. 8), whose maximum amplitude is increased by a factor of \sqrt{BT} with respect to the input amplitude.

This means that the ratio of peak output power to input power is equal to the BT product of the chirp pulse and, for a given bandwidth, the degree of increase P^{out}_{_{—}}ₘₐₓ/Pᵢₙ can be freely set by the pulse duration T of the transmission pulse. The compressed pulse has the full bandwidth B and its mean pulse duration is 1/B. The achievable time resolution is thus solely determined by the transmission bandwidth. Two adjacent compressed pulses can still be separated from one another if they are spaced by at least 1/B, i.e. if the uncompressed chirp pulses are offset by exactly this spacing with respect to one another.

The compression process is reversible; a carrier-frequency pulse with an envelope similar to sinx/x can be transformed into a chirp pulse of approximately constant amplitude by means of a dispersive filter with a suitable frequency/group run-time characteristic. In doing so, the sinx/x-like pulse is subjected to a time-spreading by a factor of BT.

Chirp pulses produced in the transmitter, transmitted via a channel subject to interference and compressed in the receiver have a great advantage compared with uncompressed signals with regard to S/N. The particular advantage of chirp signals (or time-spread signals in general) predestined for channel measurement is their system gain in the signal-to-noise ratio due to the time-compression at the receiver end, which when quoted in dB is calculated as 10·log(BT).

In the following example, information symbols at a symbol rate D are to be transmitted via a message channel of bandwidth B.

A chirp pulse of length T is used as the correlation sequence for time-spreading. Such a chirp pulse weighted by the symbol value is generated for each individual symbol. Accordingly, a symbol is spread in time to a length of T. The spacing Δt of adjacent chirp pulses then follows directly from the symbol rate D[baud] and is Δt=1/D. Depending on this pulse spacing, the resulting chirp pulses may overlap in time. The number n of pulses, which overlap at any point in time, is determined as the quotient of chirp duration T and pulse spacing Δt.

The maximum available transmitter power P is used in one transmission period for transmitting the spread signals. This power is divided between the n-times overlapping chirp pulses. Each individual chirp pulse is therefore transmitted with a power of P/n.

Due to the time-compression in the receiver, a chirp pulse undergoes a power increase of Pₒᵤₜ_{_{—}}ₘₐₓ/Pᵢₙ=B·T. If n-times overlapping chirp pulses are received and compressed with an input power of Pᵢₙ, then the peak power of an individual pulse is Pₒᵤₜ_{_{—}}ₘₐₓ=Pᵢₙ·B·T/n.

According to the invention, the same correlation sequence is used for the time-spreading of the information symbols and of the reference symbols (for the assessment of the channel). In order to transmit the reference symbols sent during the measuring interval with a preferential S/N ratio compared with the information symbols of the data packet, it is sufficient to increase the symbol spacing of the reference symbols at constant peak power to such an extent that fewer pulses overlap, i.e. so that the value n decreases.

If the pulse spacing Δt is equal to or greater than the chirp duration T, then a chirp pulse will be transmitted with the full transmitter power P. The peak power after compression at the receiver end is then: Pₒᵤₜ_{_{—max}}=Pᵢₙ·B·T.

In the simplest case, the condition Δt=T is ful-filled when only one single reference pulse is sent during the measuring interval. In the example presented, two reference pulses are transmitted. It will be shown that the spacing to be chosen for them depends not only on the chirp length but also on the expected delay spread of the transmission link.

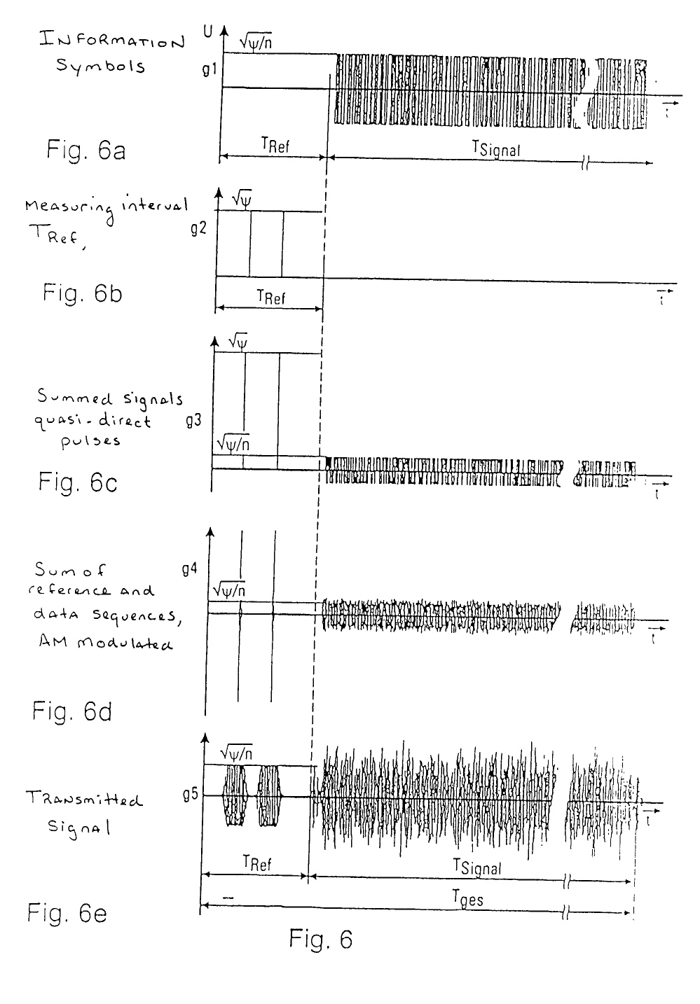

The input signal g1 (see FIGS. 3 and 6a) contains the reference symbols to be transmitted, which are brought together in data packets of length T_{signal}. In the example, g1 is a signal consisting of bipolar rectangular pulses.

In the measuring interval designated by T_{Ref}, a pulse generator (G) 30 generates a sequence (two in the example) of reference symbols g2, whose position is shown in FIG. 6b. Rectangular-shaped pulses are produced, which are increased in their pulse power compared with the pulses of the signal interval by a factor of n=D·T. (D is the symbol rate in the signal interval, T the chirp duration and n is the number of pulses in the signal interval which overlap one another after the time-spreading).

According to the maximum delay spread of the transmission channel to be expected, the spacing in time of the two reference symbols is chosen to be at least large enough so that the reflections of the first reference symbol occurring during transmission can completely die away in the interval between the pulses.

As the signal interval T_{signal} and the measuring interval T_{Ref} do not overlap, the input signal g1 and the reference signal g2 can be added together without superimposition with the aid of a summation stage 31.

The summed signal g3 is subsequently fed to a pulse shaper 32, which converts each rectangular pulse of the summed signal into a quasi Dirac pulse with the same energy and thus undertakes the actual frequency spreading. The sequence of needle pulses produced (FIG. 6c) is fed to a low-pass filter 33 and thus limited in its bandwidth to half the transmission bandwidth. The runtime behaviour of the low-pass filter exhibits an increase shortly before the limiting frequency so that the individual needle pulses are each transformed into si pulses, whose shape accords with the known si function si(x)=sin(x)/x.

After this, the si pulse sequence is fed to an amplitude modulator 34 (designed for example as a four-quadrant multiplier), which modulates these signals onto a carrier oscillation of frequency f_{T}, which is produced by an oscillator 35, so that carrier-frequency pulses with a pulse-by-pulse si-shaped envelope are produced at the output of the amplitude modulator, as shown in FIG. 6d. The output signal of the amplitude modulator has the same bandwidth as the transmission channel. Put in another way, the sequence of reference and information symbols has undergone a frequency spread over the full channel bandwidth.

The pulses generated in this way have an approximately rectangular-shaped power-density spectrum in the transmission-frequency range. Therefore, the measuring-interval reference pulses are ideal for use as a test signal for determining the pulse response of the channel.

A dispersion filter (chirp filter) 36 is connected after the amplitude modulator, which filters the modulated carrier signal g4 according to its frequency-dependent differential run-time characteristic (time spreading). This process corresponds to interleaving the carrier signal with the weighting function of the chirp filter. The result of this operation is that each of the individual carrier-frequency pulses is transformed into a chirp pulse and thus spread on the time axis (FIG. 6e). The reference chirp pulses, free from superimpositions, appear during the measuring interval, each having the same power, which is used in the signal interval for transmitting n overlapping chirp pulses. They are thus produced with n times the power when compared with an individual pulse in the data packet and are thus transmitted with a signal-to-noise ratio which is better by a factor of n.

The output signal of dispersive filter 36 is transmitted to the receiver via the message channel. Also included here in the message channel are all other transmission stages such as transmitter end stage, receiver filter, receiver amplifier, etc.

The received signal g6, which contains the measuring-interval and data-packet chirp pulses as well as the reflections of these pulses, passes through a dispersive filter 37 whose frequency-dependent differential group-run-time characteristic is complementary to the characteristic of dispersive filter 36 on the transmitter side of the system. In doing so, the individual chirp pulses are compressed in time, i.e. converted to carrier-frequency pulses with an envelope similar to sin(x)/x.

As the superimposed reflections of the transmitted chirp pulses are also chirp pulses, i.e. they have the same frequency/time characteristic, they are also compressed in the same way.

The output signal of the dispersive filter is subsequently fed to a demodulator 38 and a downstream low-pass filter 39, which rids the signal of the high-frequency carrier oscillation. The compressed and demodulated signal g7 appears at the output of the low-pass filter 39, which has interference superimposed upon it due to the multipath propagation.

The signals are evaluated during the measuring interval T_{Ref} in a Determination of coefficients circuit block 40. Within this circuit block, the compressed and demodulated reference signal including the superimposed multipath reflections is present. This therefore provides an echogram for assessing the channel, which displays the reflections superimposed on the transmission link with sin(x)/x-shaped needle pulses.

The calculated pulse response of the transmission channel is passed to equalizer 41, which compensates for the reflection components superimposed on the information symbols within the signal period T_{signal}. The output signal of equalizer 41 is fed to a sample-and-hold stage 43. This despreads the signal in the frequency domain once more. The result of this process is that the transmitted symbols are once again available in the form of rectangular pulses.

Due to their high time resolution and the transmission which has been protected in particular against interference, the demodulated reference pulses can also be called upon by a sampling control circuit 42 in the receiver.

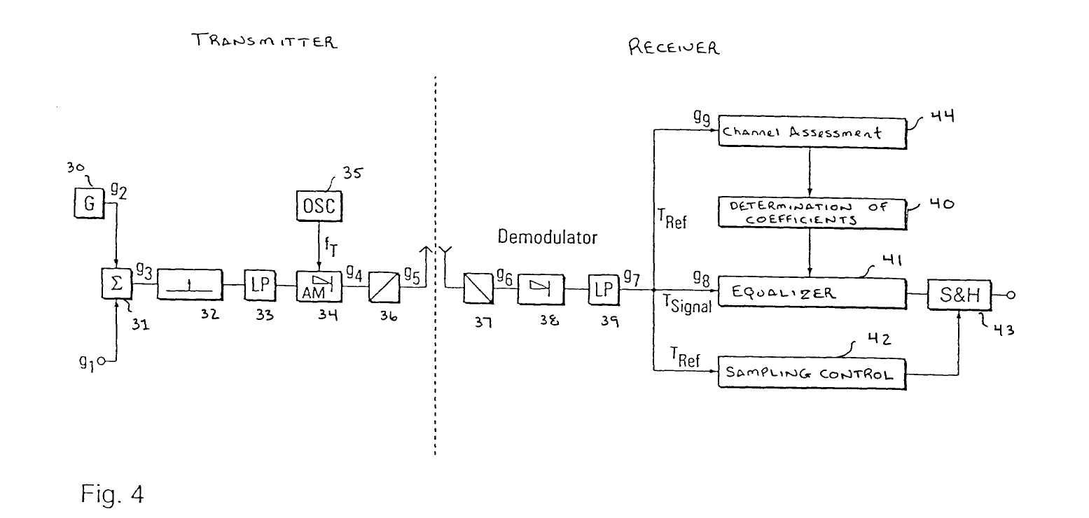

In a further exemplary variant shown in FIG. 4, an additional circuit block for channel assessment 44 is inserted before the determination of coefficients 40, which subjects the response of the channel to the reference symbols to an additional mathematical algorithm with the objective of determining the pulse response of the channel even more accurately.

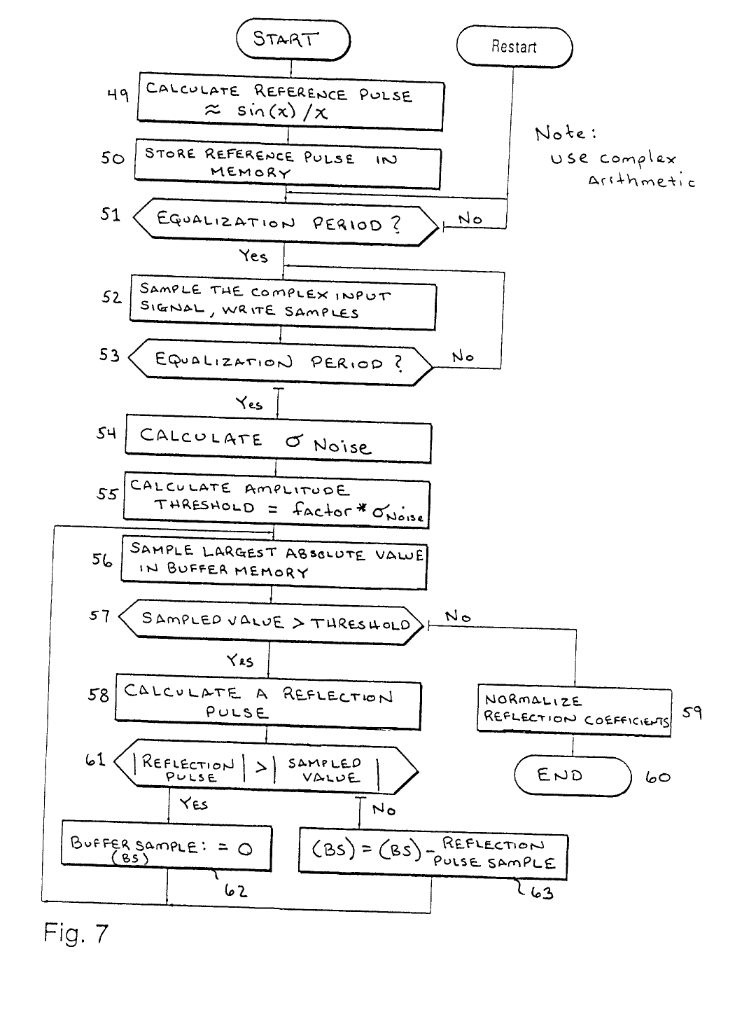

One possible algorithm for assessing the channel is shown in FIG. 7 in the form of a flow diagram. In contrast to known algorithms, this is a “parametric” channel assessment. This means that discrete multipath echoes are detected and their respective parameters, amplitude, phase and timing, referred to in the following as “reflection coefficients”, are assessed.

On first starting after calculating a reference pulse 49, the reference pulse (i.e., an undistorted symbol) is first analysed and consigned to a memory 50. The next stage is to wait for the start of an equalization period 51. During the equalisation period, the input signal is stored in a buffer memory 52. After the equalisation period 53, the contents of the buffer memory are evaluated. First, the standard deviation of the noise is calculated by interpreting as noise the signal before one or more symbols contained in the equalization period 54. An amplitude threshold is calculated from this standard deviation 55.

A loop now begins, including the steps of:

1. locating for the sample with a maximum absolute value in the buffer memory and interpret this as reflection coefficient 56;

2. determining whether the sampled value lies above a threshold 57;

3. if yes, calculating a reflection pulse whose absolute value, phase and timing are determined by the reflection coefficient while its form is given by the reference pulse 58;

4. if no, terminating the loop 60 after normalizing the reflection coefficients found up to this point with respect to the reflection coefficient with the maximum absolute value and return this as a result 59;

5. following the “Yes” branch, subtract the calculated reflection pulse from the contents of the buffer memory by sampling 61;

6. if the absolute value of a sample of the reflection pulse is greater than the absolute value of the time-corresponding sample in the buffer memory, write the difference of the samples into the memory 63;

7. otherwise, writing a zero in this position in the buffer memory 62, and returning to step 56.

One or more reference symbols are transmitted during one equalisation period. In the simplest case, the time-compressed signal h(t) of a reference symbol is interpreted as the assessment of a channel-pulse response. An improved assessment of the channel pulse response due to a reduction in noise, can be obtained by carrying out an averaging over several reference symbols. A filtering of the threshold value will also suppress noise. In doing so, the threshold-value-filtered channel-pulse response h_{Sch}(t) is interpreted as noise wherever the absolute value of h(t) is less than an amplitude threshold to be determined, and set to zero. The threshold is chosen, for example, as a defined fraction of the maximum or mean signal amplitude. Another possibility is to choose the threshold such that the signal still contains a fixed part (for example 95%) of its energy after the threshold value has been formed.

In order to produce a chirp signal with linearly increasing frequency by means of quadrature amplitude modulation QAM in the intermediate-frequency or high-frequency range, a complex baseband signal in the form

$$z ( t ) = {Z}_{0} \cdot exp ( j \cdot \frac{π {Bt}^{2}}{T} ) for \vert t \vert \frac{T}{2}$$

$$0 otherwise$$

is suitable. Here, B is the bandwidth of the chirp signal, T the duration and Z₀ is information to be transmitted, which is considered to be constant for the duration of the chirp signal. Sampling at a sample frequency fₛ results in a chirp sequence of N points:

$$z ( n ) = {Z}_{0} \cdot exp ( j \cdot π \cdot \frac{B}{{f}_{S} N} \cdot {n}^{2} ) for \vert n \vert \frac{N}{2}$$

$$0 otherwise$$

0 otherwise

The signal z(t) thus represents a chirp signal which can be used in the arrangement of FIG. 1. Furthermore, z(n) represents a chirp sequence which can be used as a correlation sequence in the arrangement of FIG. 2. In the present case, the sequence z(n) is a uniform, polyphase complex sequence, which however is not a necessary condition for its use in the arrangement of FIG. 2.

It is the state of the art in transmission systems to subject the symbols to be transmitted to filtering with a raised cosine roll-off filter for the purpose of producing pulses. This guarantees that the symbols fulfil the first Nyquist criterion after transmission, which ensures that no troublesome intersymbol interference occurs. It is also common to distribute the raised cosine roll-off filter between the sender and the receiver, for example by using a filter with a root raised cosine roll-off characteristic in each case. Decisive here is that the resulting transfer function of all the elements of the transmission link corresponds to the raised cosine roll-off characteristic resulting from the desired symbol rate.

A great advantage of linear chirp signals now lies in the fact that any frequency sequence, hence also a root raised cosine roll-off characteristic, can easily be superimposed by multiplying, i.e. weighting, the signal in the time domain by the desired frequency sequence. This is possible because, with the linear chirp, every point in time also corresponds exactly to a frequency point. The exact relationship f(t) between the point in time and the frequency point is given by the derivation of the phase of the chirp signal.

A sequence of the form

$$z ( n ) = {Z}_{0} \cdot exp ( j \cdot π \cdot \frac{B}{{f}_{S} \cdot N} \cdot {n}^{2} ) \cdot W ( f ( n ) ) for \vert n \vert \frac{N}{2}$$

$$0 otherwise$$

thus represents a weighted chirp sequence. The weighting function W(f) is the desired frequency characteristic, i.e. for example, the familiar root raised cosine roll-off characteristic.

Here, the function f(n) describes the relationship between the instantaneous point in time and the instantaneous frequency. For the chirp sequence used here:

$$f ( n ) = 2 \cdot π \cdot \frac{B}{{f}_{S}} \cdot \frac{n}{N}$$

applies.

When using correlation signals and chirp signals in particular, it is therefore possible to carry out the pulse-shaping filtering, which is necessary in any case, even before the transmission by appropriately pre-filtering the correlation signal or by appropriately weighting the chirp signal. This more than compensates for the disadvantage of the increased calculation effort for processing correlation signals.

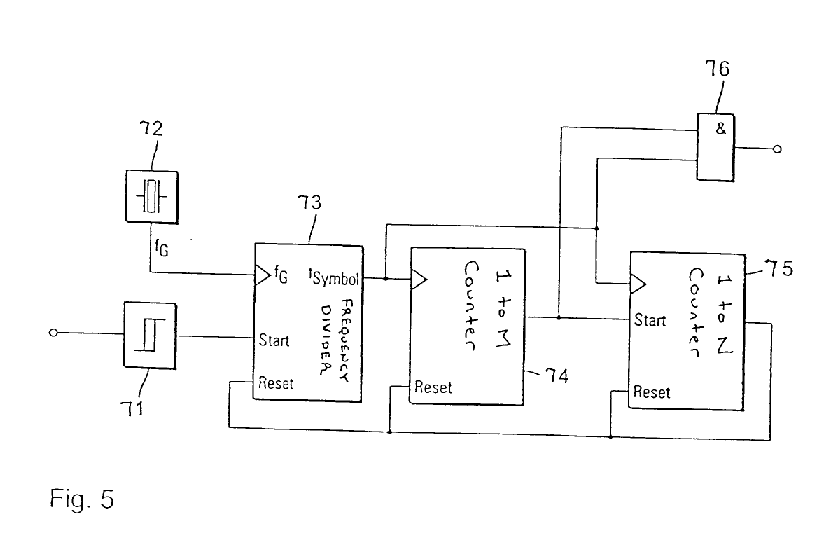

As the reference symbols are preferably transmitted without overlapping, they have a high amplitude after being time-compressed. They can thus be precisely detected in time using simple means. This opens up the possibility of deriving the sampling control of the receiver directly from the reference symbols. FIG. 5 shows an arrangement which makes this possible. This starts from the simple case where each and every reference symbol is followed by a packet of N information symbols after a time interval of M symbol clock pulses.

The reference symbol is first detected by means of a comparator 71. The occurrence of a reference symbol initiates the release of a frequency divider 73. On the input of the frequency divider is the signal from an oscillator 72 whose frequency is a multiple of the symbol clock. The symbol clock now appears at the output of the frequency divider. The phase of the symbol clock is determined by the timing of the release. As expected, the phase error of the symbol clock is small, as it depends only on the accuracy in time of the release timing.

A 1 . . . M counter 74 counts the known number M of symbol clock pulses which lie between the reference symbol and the first information symbol. A 1 . . . N counter 75 counts the known number of symbol clock pulses N which lie between the first information symbol and the last information symbol. The 1 . . . M counter and 1 . . . N counter are “one-off” counters, which remain in their current state when they have reached their final value until they are reset by a RESET signal.

In the time interval in which the 1 . . . N counter is active, a signal is present on the output of the output gate 76, the edges of which can be used to sample precisely all information symbols. As soon as the 1 . . . N counter reaches its final value, the arrangement is reset to its starting condition and waits to be activated by the next reference symbol.

The present invention combines a frequency-spreading method with a time-spreading method for transmitting message signals. In order to achieve the best possible spectral usage of the transmission channel, the symbols to be transmitted are frequency-spread. To differentiate from other frequency-spreading methods, the frequency spreading here is not carried out using a symbol-by-symbol multiplication with a code sequence but by clocking-up or forming quasi Dirac pulses with subsequent filtering.

As a result of frequency spreading, each individual pulse to be transmitted has an approximately rectangular spectral power-density over the whole frequency range of the transmission. Due to this broadband capability, the frequency-spread signals are resilient to narrowband interference.

Furthermore, an important characteristic of the invention consists in the frequency-spread symbols of the whole transmitting period (i.e. reference and information symbols) being additionally time-spread before transmission. As a result of this time-spreading, the pulse energy of the individual symbols is distributed over a longer period of time. This makes the transmission more resilient to short-term interference. The symbols time-spread in this manner are re-compressed in time in the receiver.

Due to this compression, there is a system gain in the signal-to-noise ratio, which is directly dependent on the size of the time spread. The frequency-spread symbols are particularly suitable as test signals for determining the channel characteristics because of the rectangular-shaped power-density spectrum.

As a result of this, frequency-spread symbols are sent out in a special measuring interval for assessing the channel in order to excite the channel with equal intensity over the whole frequency range. The pulse response of the channel is recorded in the receiver and used as the input value for the echo compensation.

When transmitting at high symbol-data rates over message channels which are subject to interference, the compensation for the multipath distortion requires a very accurate determination of the channel parameters. A condition for this is a transmission of the reference symbols which is especially safeguarded against interference. This means that they would have to be sent out with increased power when compared with the information symbols. However, in power-limited systems, transmission always takes place with the same maximum power within one sending period. Because of the symbol-by-symbol spreading, the information symbols transmitted can overlap to a greater or lesser extent depending on the symbol rate and the length of the spreading sequence so that the emitted transmitter power is always spread across several symbols. On the other hand, the reference symbols for assessing the channel, which are transmitted in the measuring interval, are positioned according to the invention so that they are free from overlaps and are thus transmitted with the full transmitting power. With regard to power, they are therefore increased in comparison with the individual information symbols and appear at the receiver with an increased S/N ratio.

Both the reference symbols for assessing the channel and the information symbols pass through a common device in the transmitter in which first the frequency-spreading and then time-spreading are carried out. The receiver is also designed correspondingly and first carries out the compression in time and then the despreading in the frequency domain.

The transfer of the reference symbols is thus integrated within the data transmission in a very simple manner. No additional special transmitter or receiver modules, costly filter devices or additional correlators are required for determining the channel parameters.

The spreading methods used already demonstrate their advantages (high immunity to narrowband and broadband interference) in the pure transmission of information. These advantages are particularly concentrated when additionally used for determining the channel parameters.

It has been described above—for example with reference to FIG. 3—how a chirp signal can be used as a correlation signal. A chirp signal as such is known and reference is merely made here once more to the important characteristics of a chirp pulse or a chirp signal. Chirp pulses are linear frequency-modulated pulses of constant amplitude of duration T, during which the frequency continuously changes from a lower to an upper frequency by rising or falling linearly. The difference between the upper and lower frequency is represented by the bandwidth of the chirp pulse. The total duration T of the pulse multiplied by the pulse bandwidth B is described as the extension or spreading factor. FIG. 8 shows the envelope of a compressed pulse which is produced when a chirp pulse passes through a dispersive filter whose phase response is parabolic and whose group run-time behaviour is linear.

The preparation of the signal by frequency and time spreading has been described above. This combination of frequency and time spreading offers particular advantages in the suppression of interference in the transmission link. It should be emphasised that both frequency and time spreading can be integrated to good effect into high-speed methods for data transmission with limiting data rates. If transmission takes place at the highest data rates, then a powerful equalisation is required to suppress multipath effects. The prerequisite for this is the described assessment of the channel.

It will now be described below how the methods of frequency spreading and time spreading can be introduced to a multiple-access system in a new manner, where the most important objective will be pursued, namely to guarantee the highest flexibility of the subscriber accesses with the maximum possible immunity to interference in each case.

The channel resources available for transmission are the channel bandwidth B and the maximum achievable (or allowable) transmitter power P. Particularly when it is required to establish a point-to-multipoint system, the channel resources must be effectively managed. This does not mean a one-off optimisation and adjustment, such as when setting up a directional transmission link perhaps, but a dynamic matching of the bandwidth requirements of the individual subscribers under likewise changing ambient conditions.

The access system according to the invention is able to work under at least the following operating conditions:

different data rates from subscriber to subscriber, asymmetrical data rates

varying ambient influences (noise, interference signals)

different and varying multipath conditions for different subscribers

different and possibly variable distances between the subscribers and the base station

variable traffic density

the BER requirements (BER=bit error rate) are also different for the different subscribers depending on the nature of the data to be transmitted (speech, music, video, online banking, etc.) The system should therefore also guarantee that the bit error rates required by each subscriber depending upon the type of data to be transmitted are maintained in every case.

A transmission system which must respond to so many variable parameters and at the same time guarantee acceptable individual bit error rates, demands, according to the invention, the highest possible flexibility and at the same time the activation of all frequency and power reserves of the channel—in short, the full utilisation of the channel resources at all times.

According to the present invention, a(n) (access) system is proposed to this end, which provides a data connection to the different subscriber stations and whose parameters (BER, data rate, transmitter power) can be matched to the individual requirements of the subscriber. In addition, it is to be guaranteed that the transmission system is capable of matching these parameters to changed transmission and traffic conditions of its own accord.

The access system according to the present invention combines a variable frequency spread, a variable time spread, a variable subscriber-dependent transmitter power and a variable TDMA multiplex grid size for transmitting messages.

The setting up of these parameters has a direct effect on the flexible and adaptive response to variable subscriber requirements, the transmission data rate and the BER. The resource management takes into account that the different subscribers are at different distances from the base station and that different ambient conditions (interference, multipath effects, noise) apply to the individual transmission paths. The access system according to the invention offers the possibility of suppressing noise and other interference signals.

At the same time, the variables frequency spread, time spread, transmitter power (per information symbol) and TDMA grid size can be dynamically matched to the volume of traffic and changing transmission conditions. To a certain degree they can be set up independently of one another, i.e. they are dimensionable.

The methods of time and frequency spreading can be used in combination with very different multiple-access methods, for example in TDMA systems, in FDMA systems or in a combination of TDMA and FDMA.

The TDMA access method allows the system to operate with a variable symbol rate for the individual subscriber and allows communication to take place with asymmetrical data rates. A TDMA system is able to respond to changing subscriber densities (or bandwidth requirements) in the known manner by varying the time slot lengths. In close conjunction with these characteristics must be seen the possibility of setting the transmission quality related to the subscriber so that a certain required bit error rate (BER) is not exceeded (BER on demand).

A representation of the interaction of frequency spread, time spread, variation of data rate, the TDMA time slot length and the transmitter power is described below.

The method according to the present invention is a multiple-access method with subscriber-related variable data rates and transmitter powers using an adaptive method for the frequency- and time-spread transmission of the information symbols with the following characteristics:

TDMA frame with variable multiplex grid size

In the basic structure, the access method according to the invention is designed like a TDMA method. The separation of the subscribers takes place on the time axis. In known TDMA systems (for example DECT), it is usual to provide a fixed multiplex grid size and to respond to increased data-rate requirements by putting together several time slots, which are then allocated to one subscriber.

The TDMA frame used in the access method according to the invention does not have a fixed number of slots or fixed slot widths. The multiplex grid size changes with the number and the data-rate requirements of the logged-on subscribers.

Variable frequency spread

In order to achieve the highest possible immunity of the transmission to interference, the information symbols transmitted in the time slots are frequency-spread to the channel bandwidth.

The frequency spreading takes place in two stages:

Quasi Dirac pulse formation for each individual symbol, regardless of the symbol rate (this operation is carried out in baseband and can be looked upon as the actual frequency spread).

Band-pass filtering of the quasi Dirac sequence Frequency spreading is completed by means of the band-pass filtering. A limitation of the signal spectrum to the bandwidth B of the transmission channel is achieved. An individual symbol then has a rectangular-shaped power-density spectrum over the whole available frequency range. In the time domain, the symbol flow appears as a sequence of sin(x)/x-shaped pulses. The mean width δ of this type of pulse is defined by the channel bandwidth B and is given by δ=1/B.

If there are frequency reserves before spreading, i.e. the quotient of channel bandwidth and subscriber symbol rate is greater than one, then a system gain in the signal-to-noise ratio will result from transmitting with frequency spread. This system gain is realised in the receiver by frequency compression. Associated with this is a reduction in the bit error rate. The system gain can be controlled by varying the symbol rate concerned. Reducing the symbol rate at a constant channel bandwidth automatically leads to an increased frequency spread, i.e. to a higher system gain and thus to a greater resistance to noise and narrowband interference.

Finally, the variable frequency spread allows a particular bit error rate required by the subscriber to be set even under changing transmission conditions.

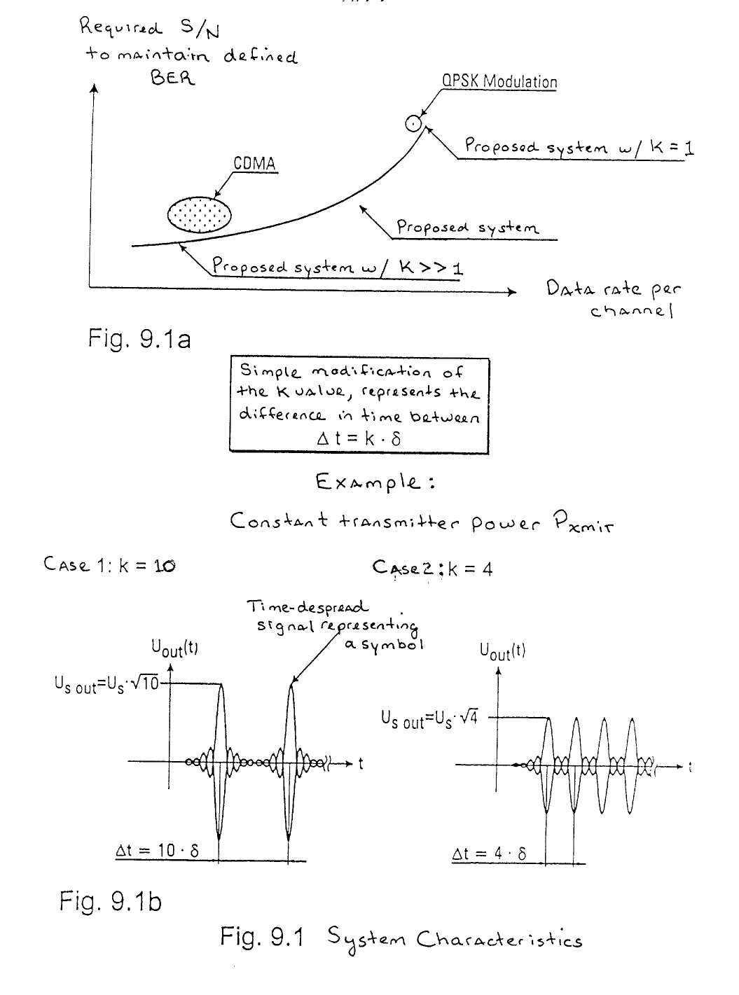

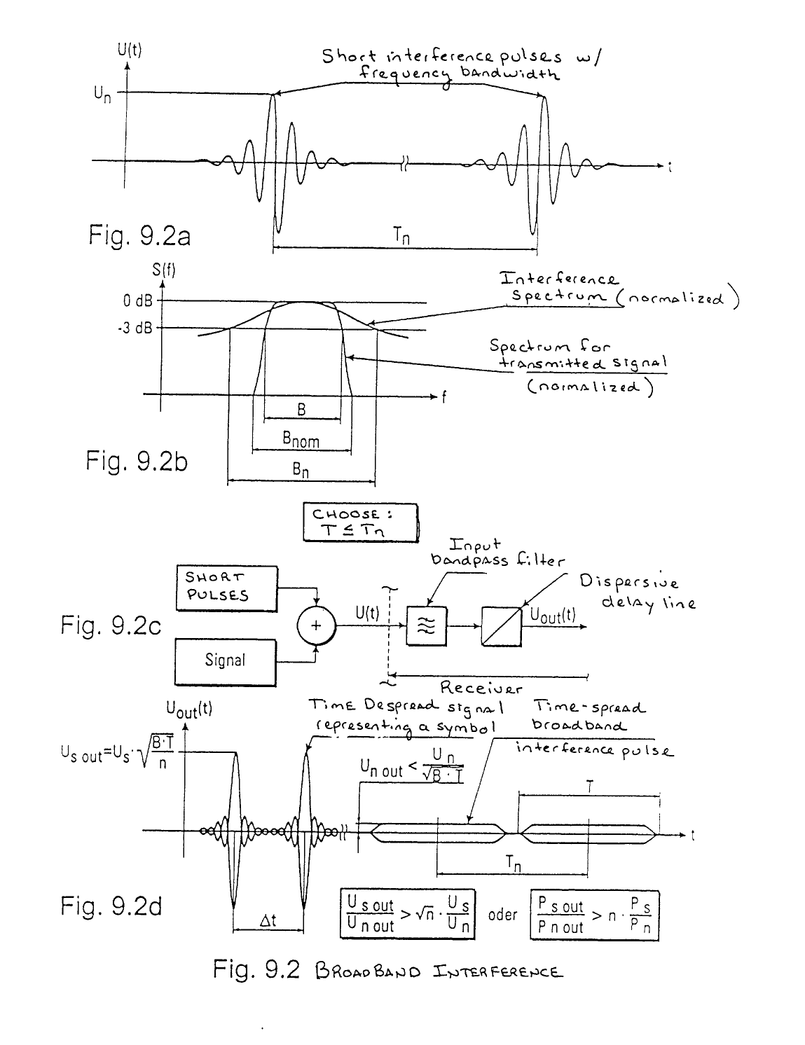

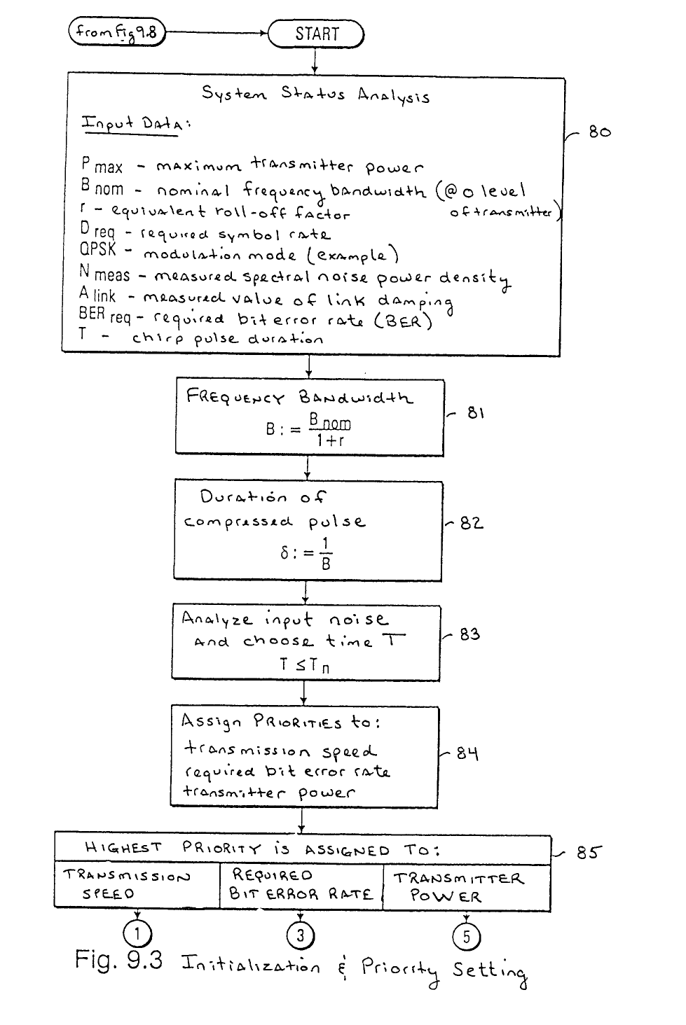

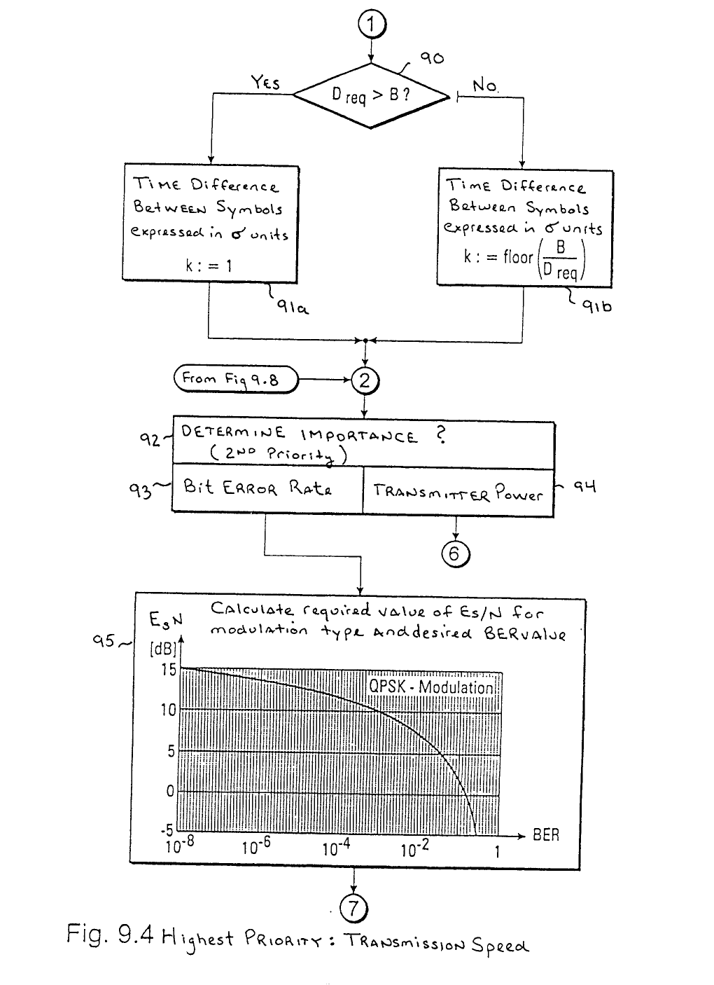

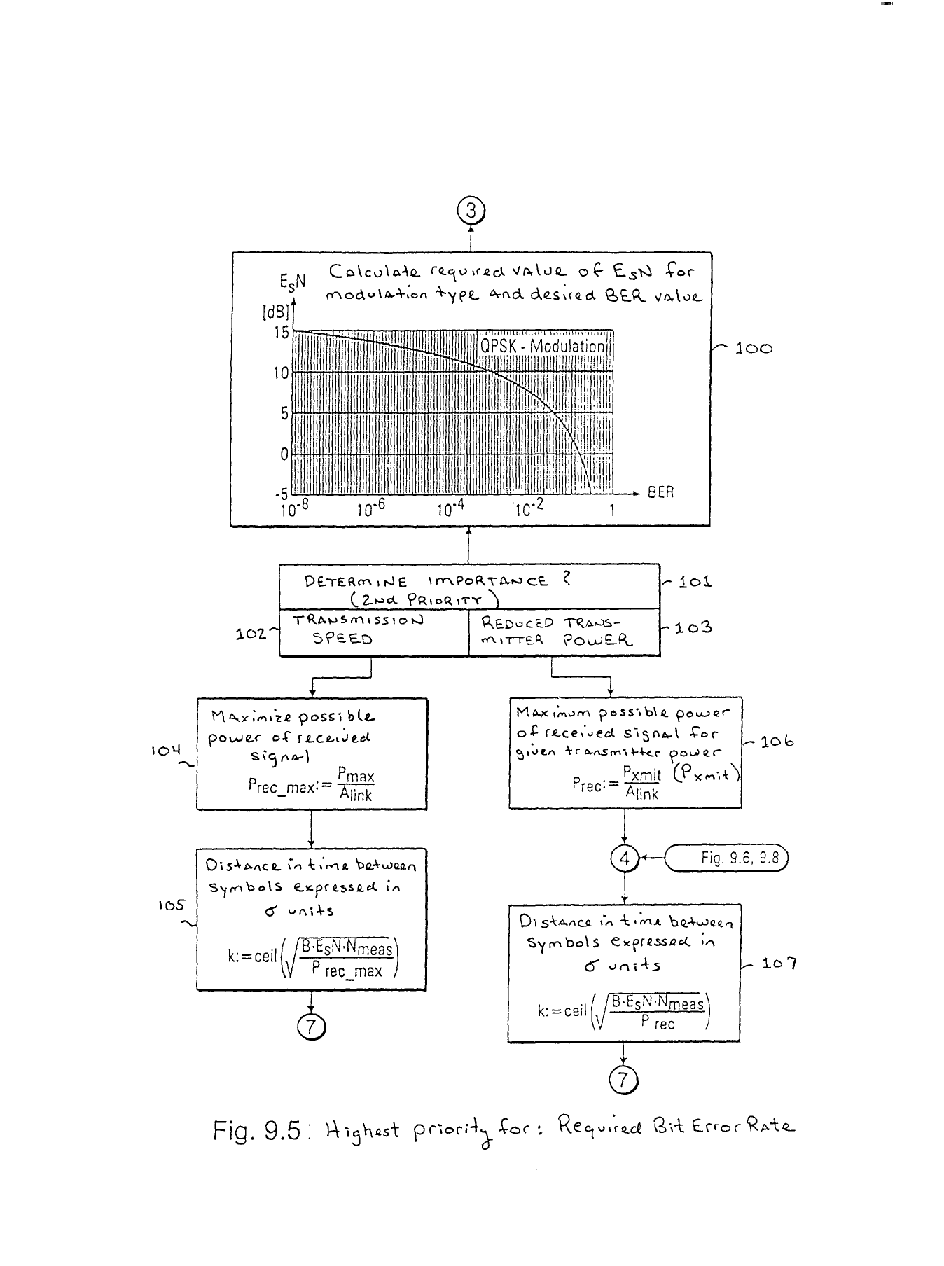

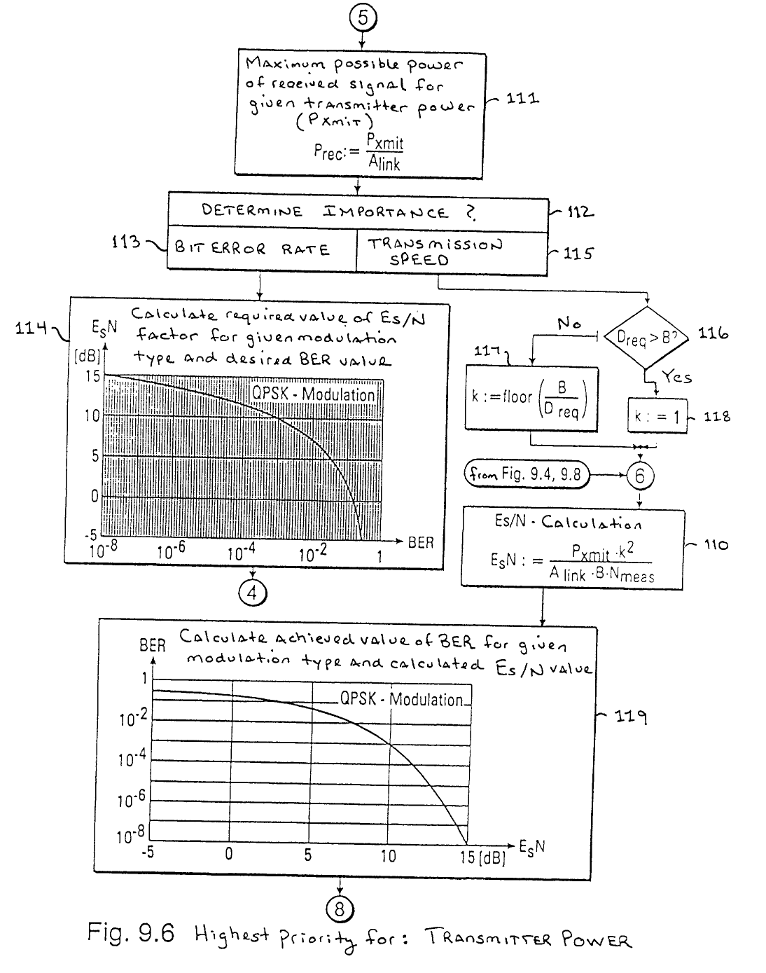

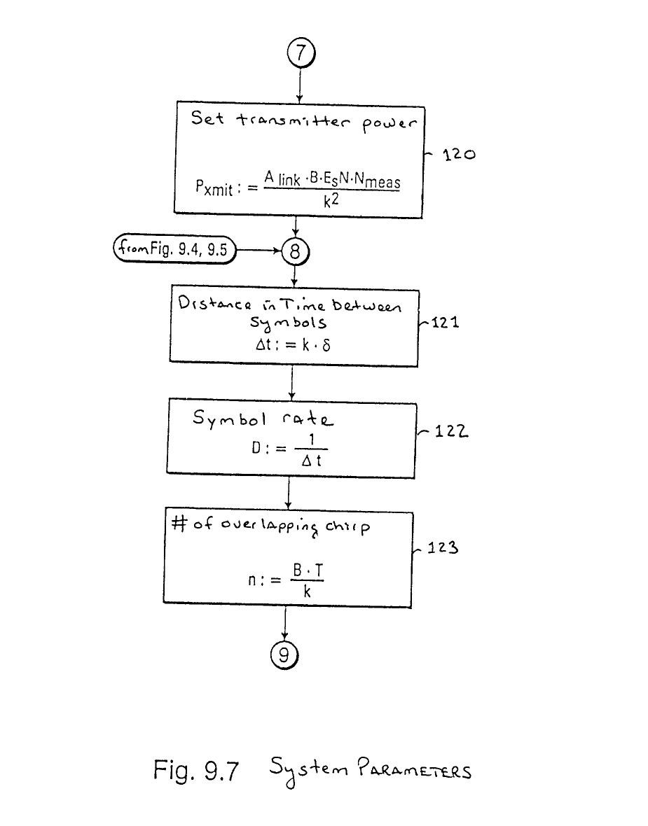

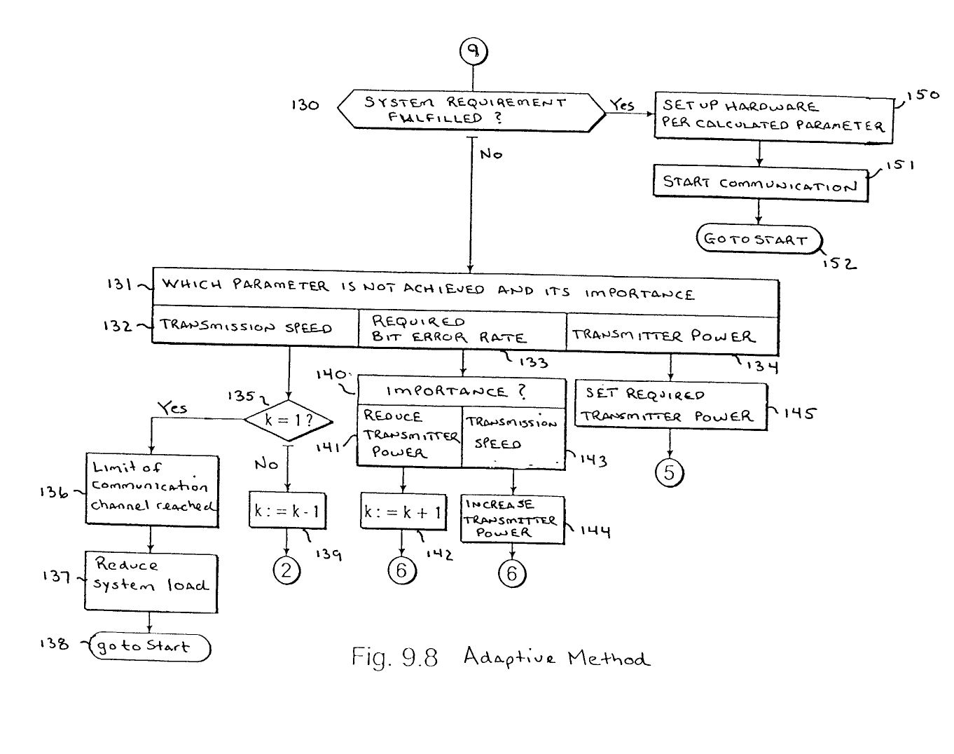

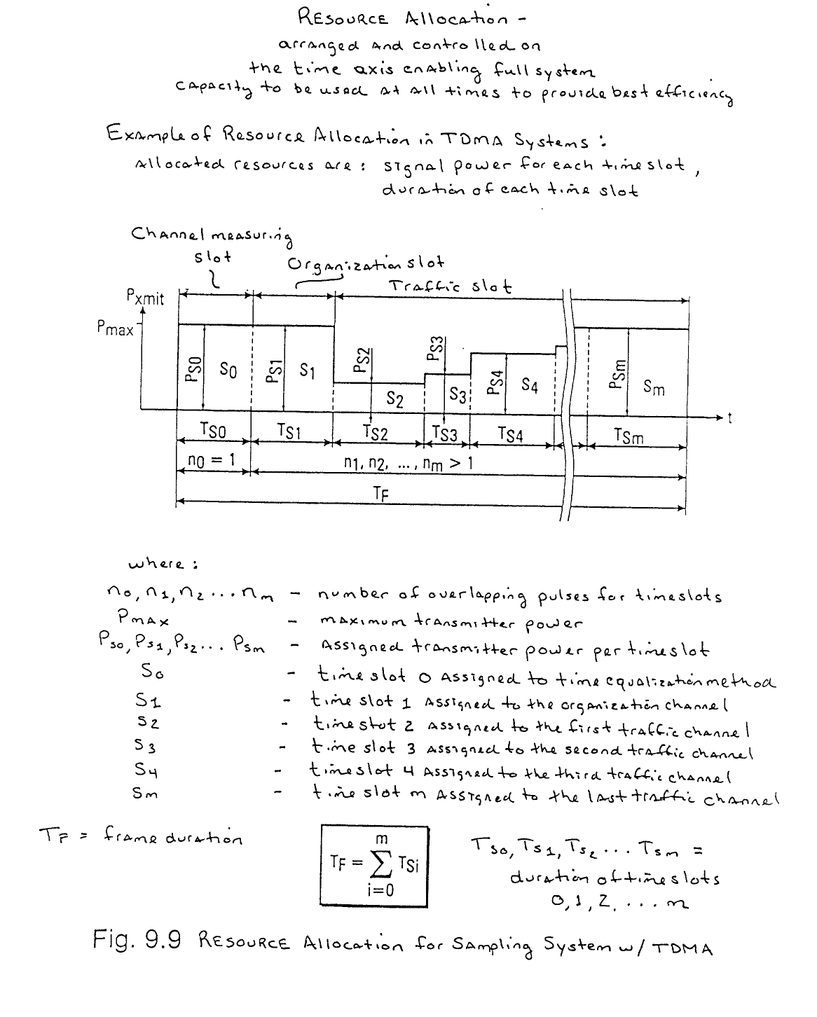

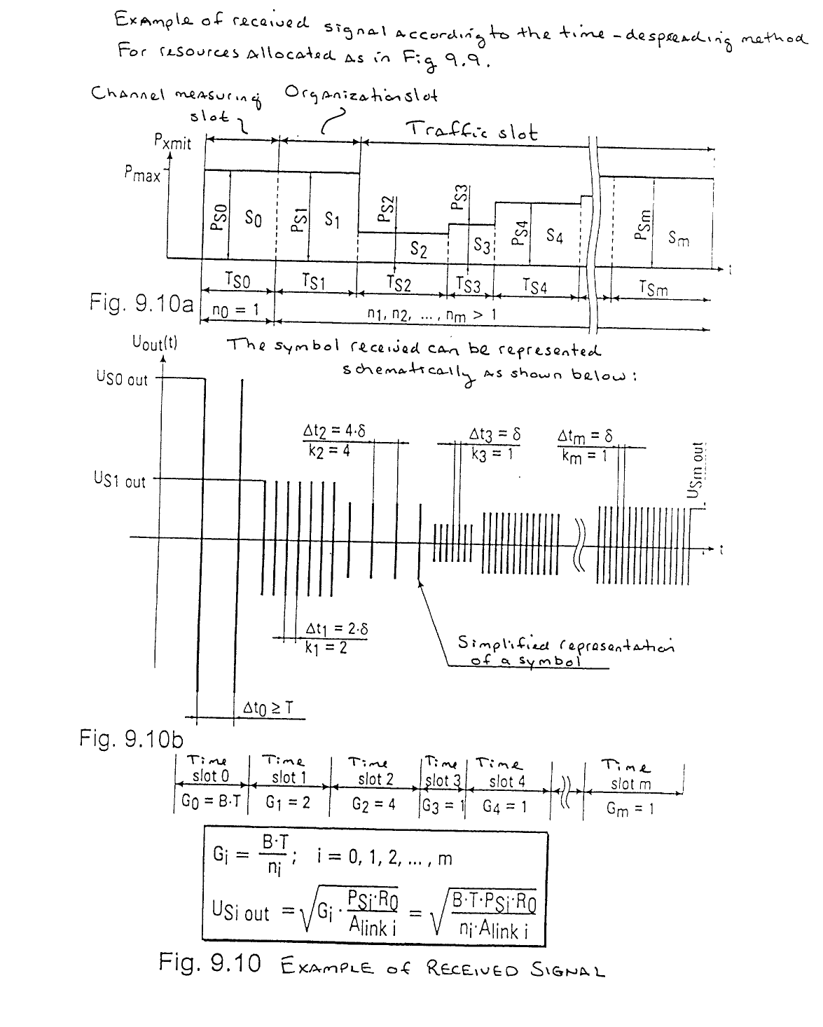

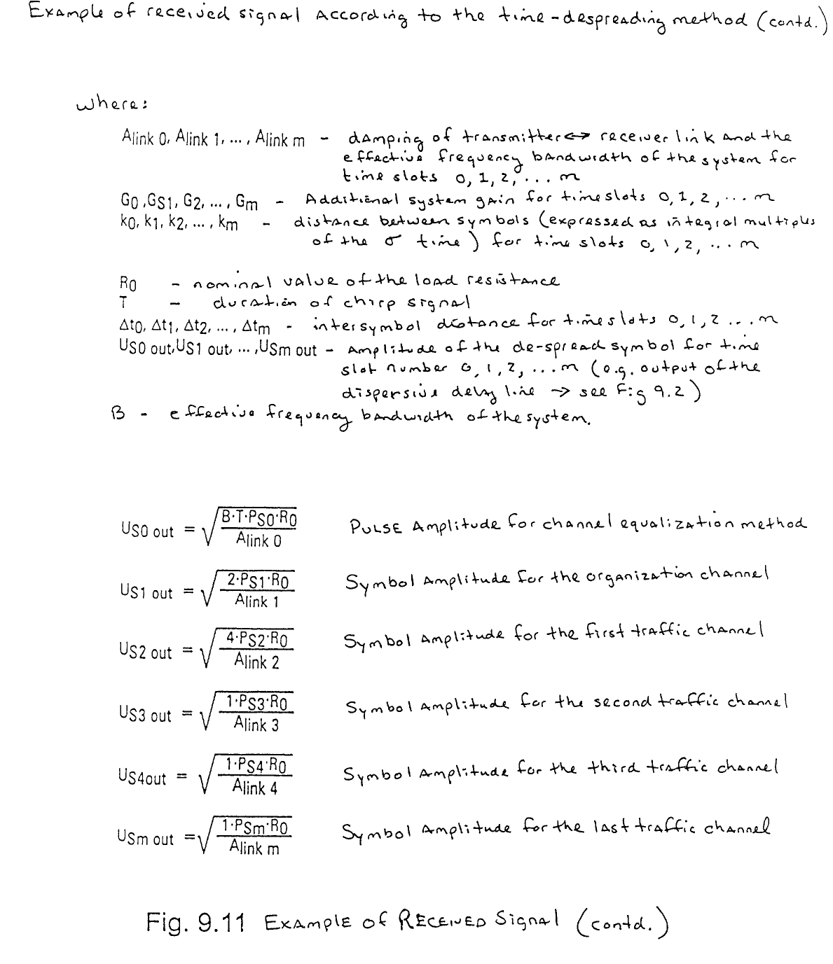

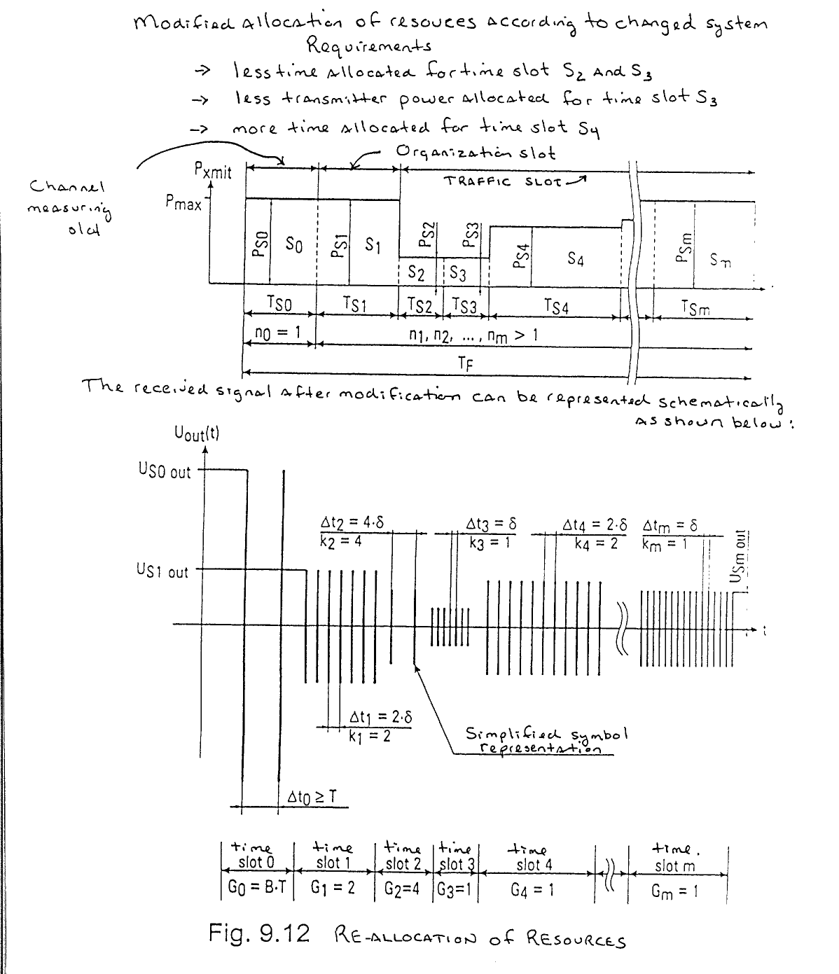

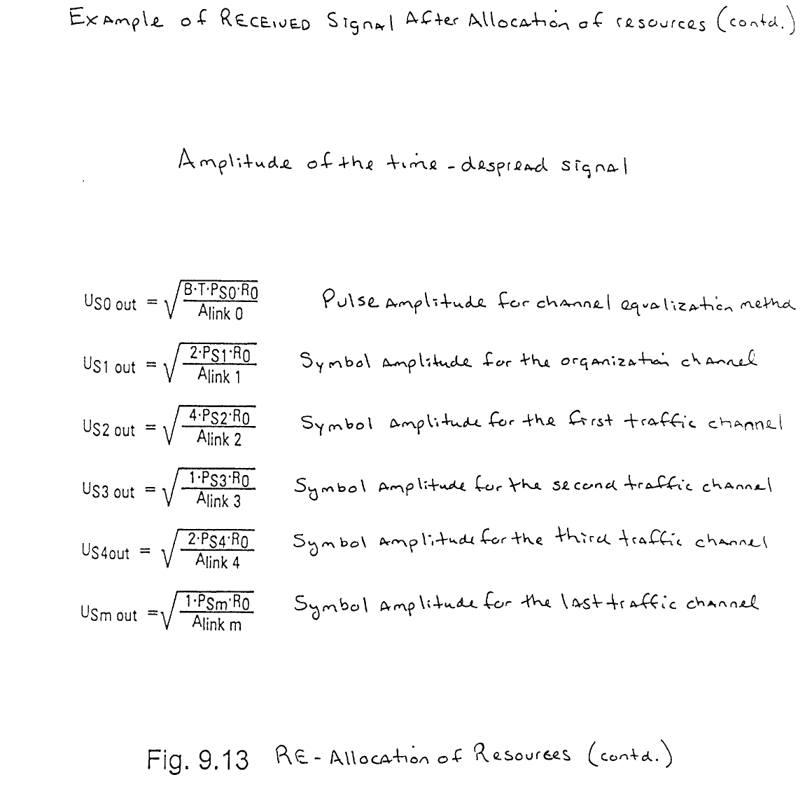

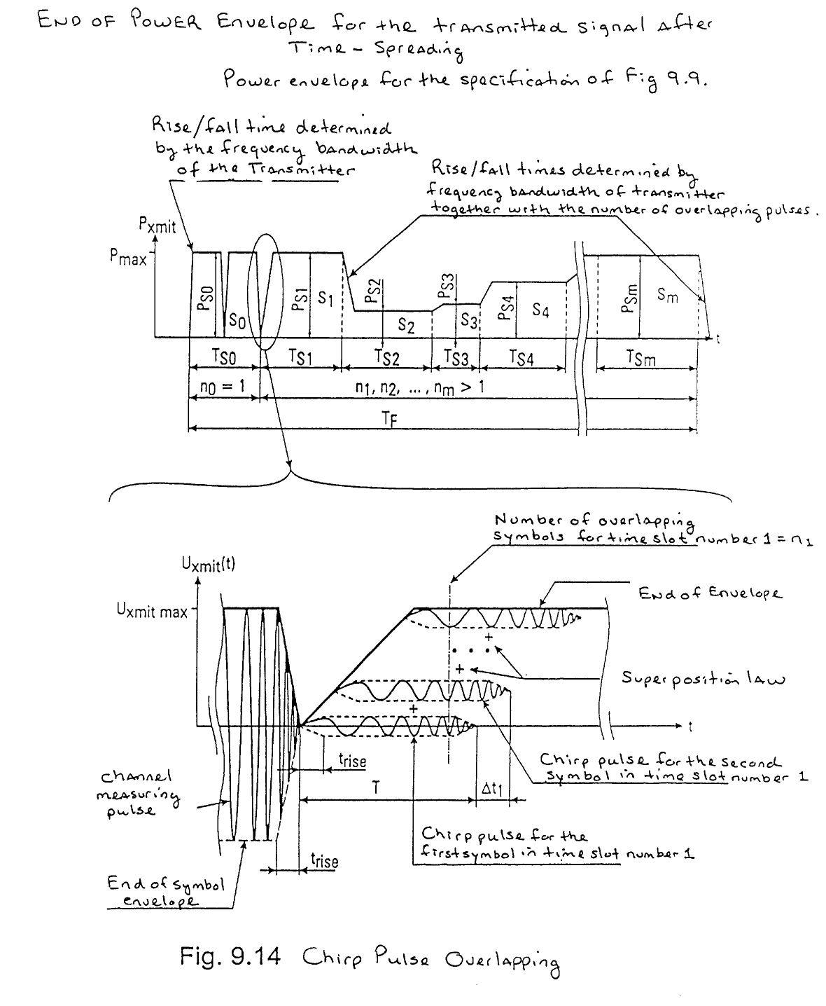

FIG. 9.1a shows a diagram in which the S/N ratio required to maintain a certain BER is shown against the data rate. The diagram shows the operating range of common CDMA systems which work with a spread spectrum method with fixed frequency spread and in comparison with this the working ranges of a QPSK system and of a transmission system according to the invention with variable frequency spread. The factor k designates the spacing of adjacent symbols in units of δ, where δ represents the mean width of a symbol which has been frequency-spread to the bandwidth B (δ=1/B). This value k can be looked upon as a measure of the frequency spread and is identical to the achievable system gain G. Whereas the CDMA method relies on transmission at a fixed data rate when the S/N ratio required is low, the variable frequency spread allows the whole range [S/N; data rate] to be traversed along the line shown. If the required BER should reduce, for example if less sensitive data is to be transmitted, then the transmission speed can be increased. In every case, the full utilisation of the “bandwidth” resource is guaranteed for all points on the line (spectral efficiency). Frequency reserves of any magnitude are automatically converted into a system gain, which is effective during data transmission.

FIG. 9.1b contains an example of frequency-(and time-) spread transmission. The frequency-spread transmission symbols were transmitted with equal transmitter power but with different symbol rates (different k factors). The signals appearing at the output of the receiving end compression filter are shown. The peak amplitudes U_{s out} of the compressed signal are increased by the factor √k compared with the amplitude Uₛ of the received spread signal. The corresponding increase in power has the value k. The system gain G=k can be varied by means of the symbol rate.

The frequency-spread symbols are time-spread before transmitting to the receiver. The sin(x)/x pulses of width δ produced symbol-by-symbol are converted to chirp pulses of length T before transmission. The chirp duration thus determines the maximum achievable time spread [=T/δ]. A particular advantage of time-spread transmission consists in suppressing broadband interference. For this reason, the chirp duration T is matched to the broadband interference periodically occurring in the channel. This matching is illustrated in FIG. 9.2.

FIG. 9.2a shows possible broadband transmission interference which occurs with a period Tₙ. The bandwidth Bₙ of the interference pulses is larger than the effective channel bandwidth B.

FIG. 9.2b shows the spectra of the transmission signal and the superimposed broadband interference. Bₙ is the effective bandwidth of the interference signal, limited by the input filter in the receiver. Bₙₒₘ is the total available (licensed) bandwidth of the channel and B is the channel bandwidth limited by the roll-off filtering in the transmitter and receiver, which, for better discrimination, will be described in the following as the effective bandwidth.

FIG. 9.2c shows how the interference pulses are additively superimposed upon the transmission signal. The signal mix of data and interference pulses first passes through an input filter in the receiver and then a dispersive delay line (chirp filter).

FIG. 9.2d shows the output signal Uₒᵤₜ(t) of the delay line. The compressed data pulses and the extended interference components are shown separately for better understanding. The amplitude of the data pulses before compression is designated with Uₛ. Uₙ is the amplitude of the superimposed broadband interference pulses. The amplitude of the data pulses at the output of the compression filter has increased by \sqrt{(BT)/n} times while the amplitude of the interference pulses has reduced by 1/\sqrt{(BT)} times. Compared with the uncompressed receiver signal, the signal-interference ratio has increased by a factor equal to the square root of n when considering the amplitudes and a factor n when considering the power. The two extended interference pulses are shown on the right of the diagram. They have been extended to the duration T as a result of the spread to which they have been subjected. In principle, it is possible to spread broadband interference to any length required by choosing an appropriately high chirp duration T. However, a boundary condition remains in the technical feasibility of the chirp filter. If the transient interference described occurs periodically, care must be taken when sizing the system to ensure that the spread pulses do not overlap in order to avoid an unwanted increase in the extended interference signal U_{n out}. In order to rule out this possibility, the chirp duration T to be set must be chosen to be less than the period Tₙ of the interference pulses.

As a result of the time spread, the signal to be transmitted acquires a resistance to broadband interference. The size of the time spread is agreed (set) when making a link between the base station and the subscriber station depending on the occurrence of periodic broadband interference pulses. Hence the reference to a variable time spread.

A different transmitter power can be assigned to the individual subscribers or the different timeslots.

The setting up of these parameters has a direct effect on the flexible and adaptive response to variable subscriber requirements, the transmission data rate and the BER. The resource management takes into account that the different subscribers are at different distances from the base station and that different ambient conditions (interference, multipath effects, noise) apply to the individual transmission paths. The use of frequency spreading and time spreading when transmitting messages offers the possibility of suppressing noise and other interference signals.

The variables TDMA grid size, frequency spread, time spread and transmitter power can be dynamically matched to the volume of traffic, changing transmission conditions and subscriber requirements. To a certain degree they can be set up independently of one another. As a rule, however, it is not the individual variables that are changed but their interaction and inter-linking, as the following embodiment shows:

The embodiment shows the principle by which the frequency spread, time spread and transmitter power are matched to one another. It is shown how these parameters can be matched (adapted) to suit subscriber requirements, transmission conditions and the traffic density.

In the program scheme used for this, first of all the channel characteristics are analysed, then the demands of the subscribers on the transmission are interrogated and finally, taking this data into account, the size of the time spread, the frequency spread and the necessary transmitter power are determined. The connection to the subscriber is then made using this data. A connection to be made is essentially characterised by three properties:

the desired transmission speed (transmission data rate)

the required bit error rate

the desired (possibly also the maximum allowed) transmitter power.

These three values are advised by a subscriber station when it wants to establish a data connection to the base station. Depending on the nature of the data transmitted, the three requirements can be assigned different priorities. Hence, the bit error rate which is required for transmitting speech can be less than the BER required for transmitting sensitive bank data. For transmitting speech, the priorities would, for example, be arranged in the order [transmitter power, transmission speed, BER] and for transmitting bank data in the order [BER, transmitter power, transmission speed] for example.

The transmission of extremely long files (for example graphics files) requires a higher transmission speed than perhaps the transfer of short database queries. In other areas, perhaps in medical applications, the permissible transmitter power may be limited to a very low level while no increased requirements are placed on the transmission speed.

In the diagrams of FIG. 9.3 to FIG. 9.8 an exemplary program sequence is demonstrated, which accepts the subscriber requirements (including the set priorities) and, using frequency or time spreading and power control, establishes a connection, matched to the channel characteristics, with the highest possible immunity to interference.

A subscriber's request for a connection marks the starting point in time. The base station has already reserved a time slot of a particular length in the TDMA frame for this connection. (This time slot can be increased or decreased as the connection proceeds, which requires agreement with the remaining subscribers and requires some protocol-related effort. A lengthening of the assigned time slot is necessary, for example, when the subscriber requests an increase in the data rate during a live connection without it being possible to reduce the BER or increase the transmitter power). A time slot of constant length is required for the following program scheme.

The program sequence plan is divided into five parts, which are each shown in their own diagram. The first part (see FIG. 9.3) describes the input data at the time of logging on and the possible priorities which a subscriber can set. Depending on the selection made (transmission speed, required BER, transmitter power), branching to the program sections in FIG. 9.4, FIG. 9.5 or FIG. 9.6 takes place. In these parts of the program, the third variable (priority 3) is determined from the preferred variable (priority 1) and the variable respectively assigned “priority 2”. For example, for a transmission with a desired symbol rate and a required BER, the necessary transmitter power is calculated taking into account the boundary conditions (link damping and noise power-density).

A calculation procedure is shown in FIG. 9.7, which is called up from the three previous sections of the program. The symbol rate achievable in each case for the subscriber and the possible time spread are calculated using this procedure.

The results obtained are transferred to the “adaptive procedure” in FIG. 9.8. This procedure checks whether the calculated values, i.e. those intended for the transmission (symbol rate, BER and transmitter power) are adequate for the subscriber requirements and can be realised by the transmission system. If yes, then a connection is set up to the subscriber using exactly these values. Otherwise, again controlled by set priorities, the program will run through loops by means of which the symbol rate and transmitter power are varied until data transmission using these parameters can be carried out. The adaptive procedure is likewise capable of responding to changes in the link damping and the spectral noise power-density so that a dynamic matching of the transmission system to changed transmission conditions can also be achieved.

FIG. 9.3 shows the input data which must be known to the transmission system (80). This involves either fixed values (key data), which are system-specific and do not change (e.g. maximum transmitter power Pₘₐₓ, channel bandwidth Bₙₒₘ, type of modulation, roll-off factor r), subscriber requirements (such as the required bit error rate BER_{req} or the required symbol rate D_{req}) or channel characteristics, which have to be determined in special measuring cycles (link damping Aₗᵢₙₖ, spectral noise power-density Nₘₑₐₛ).

The connection of the subscriber to the base station is organised for these input data, which are valid at the time of starting. If the “input data” data record is complete, the transmission characteristics can be defined.

To do this, the effective bandwidth B of the transmission system (the channel bandwidth reduced by the roll-off factor r due to filtering) is first determined (81).

Next, the mean width δ of a compressed pulse is calculated from the effective bandwidth B (82). The background for the calculation of δ is that in the frequency spreading process to be carried out later, each symbol to be transmitted will be converted into a sin(x)/x-shaped pulse. A pulse of this kind has the full bandwidth B and a mean time width of δ=1/B. Before transmitting, the sin(x)/x-shaped pulse is converted to a chirp pulse with the same bandwidth. The chirp pulse is compressed in the receiver. The compressed pulse again has a sin(x)/x shape and the mean width δ.

The chirp duration T is fixed in the following field (83). The chirp duration T is matched to the broadband interference occurring (possibly periodically) in the channel. If this interference has a period Tₙ, then the chirp duration T to be set must be chosen to be less than Tₙ.

In the subsequent field, it is recorded which of the three transmission variables (transmission speed, BER and transmitter power) is assigned the highest priority (priority 1) and the second highest priority (priority 2) (84). This determines the further sequence of the program (85). The corresponding program steps are described below with reference to the diagram numbers for the three possible decisions (related to priority 1):

[I]. Highest Priority on Transmission Speed (Ref—FIG. 9.4)

In the first stage (see FIG. 9.4) the necessary spacing k between adjacent symbols is calculated from the required symbol rate D_{req} and the effective bandwidth B (90 and 91a/91b). Here it is assumed that this spacing is an integral multiple of the mean pulse width δ. The distance k is given in units of δ.

In the second stage the second priority 2 is interrogated (92). Where the second priority is placed on Bit Error Rate (BER) (93), it is imperative to maintain a required BER. The ratio E_{S}/N needed in the receiver for the required bit error rate BER_{req} for the type of modulation concerned (QPSK in the example) is read from a table stored in the memory (95). Here, Es designates the bit energy and N the spectral noise power-density. For example, according to the diagram shown, an E_{S}/N of 10 dB is required for a BER of 10⁻³. Thereafter, the procedure branches to entry point 7 (See, FIG. 9.7).

The required transmitter power Pₓₘᵢₜ is determined from the calculated ratio E_{S}/N, the measured link damping Aₗᵢₙₖ, the noise power-density Nₘₑₐₛ, the effective bandwidth B and the pulse distance k. (See, step 120 in FIG. 9.7).

Thereafter, spacing Δt of adjacent symbols (i.e., symbol duration) measured in seconds is calculated from the distance factor k and the mean pulse width δ. (See, step 121 in FIG. 9.7). The transmission is later carried out with this symbol spacing Δt.

In the following stage (122 of FIG. 9.7), the intended symbol rate D for the transmission is determined.

In the next stage (123 of FIG. 9.7), the number n of chirp pulses overlapping after time spreading has been carried out is determined. In the time spread process the individual sin(x)/x pulses are time-spread by a factor φ=BT. A single pulse with a mean width δ is converted to a chirp pulse of width T. If the chirp duration T is greater than the symbol duration Δt then we can talk about a time-spread transmission of the symbols. In this case, adjacent (chirped) symbols overlap one another to a greater or lesser extent. The quotient n=BT/k (=T/Δt) gives the number of symbols which overlap at any given time. This value n can be looked upon as the actual measure of the time-spreading.

The method portion shown in FIG. 9.7 then branches to entry point 9 of the adaptive method (See FIG. 9.8).

Returning to FIG. 9.4, the case where transmitter power is assigned second priority (94) will be described. That is, transmission is to take place using the defined power Pₓₘᵢₜ. In this circumstance, the method branches to entry point 6 (See FIG. 9.6).

The achievable E_{S}/N is calculated from the transmitter power, the link damping Aₗᵢₙₖ, the noise power-density Nₘₑₐₛ, the effective bandwidth and the distance factor k (110). The achievable bit error rate for the calculated E_{S}/N may be determined from a table stored in the memory for the type of modulation concerned (QPSK in the example). The procedure branches to entry point 8 (see FIG. 9.7). As before, symbol spacing Δt, symbol rate D and the number n of overlapping pulses are calculated (121, 122, 123). The procedure branches to entry point 9 of the adaptive method (see FIG. 9.8).

The program sequences are described in detail for the case where the highest priority for the transmission is placed on achieving a certain transmission speed and, for defining a second priority, either on achieving a certain BER or on maintaining a specified transmitter power. Both priority-determined sub-procedures finally branch to the adaptive method, shown in FIG. 9.8, after all the transmission parameters have been determined. The way in which this procedure works is demonstrated in a later section.

[II]. Highest Priority on Maintaining a Required Bit Error Rate (BER) (Ref—FIG. 9.5)

The procedure starts at entry point 3 (see FIG. 9.5). The E_{S}/N necessary for the required bit error rate is determined (100).

Next, the second priority is interrogated. Where transmission speed is the second priority (102), a determination is made in relation to the maximum possible receiver power under the assumption that the transmitter emits the maximum transmitter power Pₘₐₓ (104). Then, a determination of the factor k necessary for this receiver power is made (105), i.e., what system gain G=k will guarantee a sufficiently high signal-to-noise ratio in the receiver?. Following this determination, the method branches to entry point 7 (see FIG. 9.7).

Again, the required transmitter power Pₓₘᵢₜis calculated using the calculated distance factor k. (120) (The previously completed procedure leads one to expect that, subject to a rounding error, Pₓₘᵢₜ will be roughly equal to the maximum transmitter power Pₘₐₓ). The symbol spacing Δt, the symbol rate D and the number n of overlapping pulses are then calculated (121, 122, 123), and the method branches to entry point 9 of the adaptive method(see FIG. 9.8).

In the case where a specified reduced transmitter power is second (see FIG. 9.5 step 103), the achievable receiver power is calculated for the specified transmitter power (106). Next, a determination is made of the factor k necessary for this receiver power (107), i.e., what system gain G=k will guarantee the E_{S}/N required in the receiver?. Thereafter, the method branches to entry point 7 (see FIG. 9.7).

As before, the required transmitter power Pₓₘᵢₜis calculated using the calculated distance factor k, symbol spacing Δt, the symbol rate D and the number n of overlapping pulses are calculated (steps 120 through 123). The method then branches to entry point 9 of the adaptive method (see FIG. 9.8).

[III]. Highest Priority on Maintaining a Specified Transmitter Power (Ref—FIG. 9.6)

The procedure starts at entry point 5 (see FIG. 9.3). The achievable receiver power is calculated for the specified transmitter power (111). Next, the second priority is determined (112).

Where the second priority is maintaining a specified BER (113), a determination of the E_{S}/N required in the receiver to maintain this BER is made (114). Thereafter, the method branches to entry point 4 (see FIG. 9.5), and a determination of the factor k necessary for this E_{S}/N is made (107), i.e., what system gain G=k will guarantee a sufficiently high signal-to-noise ratio in the receiver?. Once this determination is made, the method branches to entry point 7 (see FIG. 9.7).

However, where the second priority is maintaining a specified transmission speed (see FIG. 9.6) (115), a determination of the achievable factor k while maintaining the desired symbol rate D_{req}(116, 117, 118), i.e., what system gain G=k can still be achieved if transmission is to take place at a bandwidth B with a data rate D_{req}?.

Subsequently, a determination is made of the E_{S}/N which can yet be achieved using the calculated distance factor k (110). The bit error rate achievable for the calculated E_{S}/N is determined from a table stored in the memory for the type of modulation concerned (QPSK in the example) (119). Then, the method branches to entry point 8 (see FIG. 9.7).

The adaptive method shown in FIG. 9.8 will now be explained using the example of the last case discussed, i.e., case III, wherein the first priority is on maintaining a specified transmitter power, and the second priority is on maintaining a specified transmission speed.

The adaptive procedure starts at entry point 9 (see FIG. 9.8). First, a test is performed to determine whether data transmission can take place using the calculated and transferred parameters (i.e., symbol rate, BER, and/or transmitter power) (130). If the transmission system allows the operating case determined in this way, then the send/receive devices are setup (150) and the transmission begins (151). Subsequently, the procedure branches back to the start (152) (see FIG. 9.3).

If, however, the test result turns out to be negative, the system will be checked in the order of the defined priorities to see which of the required parameters are not maintained (131).

If the transmitter power is not sufficient (134), then the parameter Pₓₘᵢₜ will be set to a new value (145) and the method branches to entry point 5. The remaining parameters will also be recalculated using the newly selected transmitter power. If the transmission conditions (link damping, noise power-density) have changed in the meantime, then the changes will be included in the new calculation. When the adaptive method is reached once more, the testing starts again (130). The program will run through this loop until the necessary transmitter power has been set.

If (according to the established second priority) the required transmission speed is not achieved, it will next be checked to see whether reserves exist for increasing the symbol rate (132). If the distance factor k already has a value of 1 (135, Yes), there are no more reserves. In this case, the symbol rate will be equal to the effective bandwidth. A single symbol will have the full bandwidth, i.e. the upper limit of the symbol rate has been reached (136). Frequency spreading will not take place and the system gain is G=k=1. An increase in the transmission rate effective for the subscriber can only be achieved by extending his time slot in the TDMA frame. This requires a reduction in the overall system loading (137) and if necessary waiting for this reduced system usage. When this has been achieved, the desired connection can be made. The procedure branches to the start (138) (FIG. 9.3).

If, on interrogation, k has a value >1, (135, no) then there is a possibility of increasing the symbol rate and in return reducing the frequency spread or the associated system gain G=k. In this regard, k is initially reduced by 1 (139). In this case, an increase in the bit error rate is to be expected. Whether this increased BER can be tolerated is decided by going around the loop once more (jump to entry point 2). If the adaptive method is reached in the loop, this method starts again from the beginning until the required transmission speed has been achieved.

If (according to the established third priority) the required BER is not achieved when the system is interrogated (133), then it is decided according to the priority list (140) whether the data rate or the transmitter power can be varied (141). In the case under consideration, a fixed transmitter power has priority and therefore the method branches to change the symbol rate, in this case to reduce the symbol rate. To do this, the distance factor k is increased by 1 (142) and the symbol spacing increases. Whether the new symbol spacing is sufficiently high to maintain the desired BER is investigated by going around the loop (jump to entry point 6; see FIG. 9.6). If the procedure initiated there runs through as far as the method adaptive procedure (FIG. 9.8) then the loop will run again if necessary until the required BER is achieved.

The distribution of the transmitter power and time slot-length resources between the individual subscriber stations in a transmission system according to the invention is described below with reference to FIGS. 9.9 to 9.14.

FIG. 9.9 shows a TDMA frame of frame length T_{F}. The frame is divided into an interval T_{S0} for measuring the channel, an organisation channel of length T_{S11} and m mutually independent message channels with slot widths T_{S2}, T_{S3}, . . . T_{Sm}. Each of these time slots can be assigned a transmitter power P_{S} (P_{S0}, P_{S1}, . . . Pₛₘ). The transmitter power of the individual channels is limited to a maximum value Pₘₐₓ. The number n (n₀, n₁, . . . nₘ) is used to designate the number of pulses overlapping at any given time in the respective slot 0, 1, . . . m. The value n depends on the symbol duration achieved in the appropriate slot and the chirp duration T (N=T/Δt) If the distance factor k introduced above (the quotient of the effective bandwidth and the achieved symbol rate D) and the BT product for the chirp filter used for time-spreading are taken as the basis for the calculation, then the value n is given by n=BT/k.

It can be seen from FIG. 9.9 that each time slot can be separately assigned a slot length and a transmitter power. A consequence of the variable time spread, which has been demonstrated in the program scheme according to FIGS. 9.3 through 9.8, is the number n of overlapping pulses which differs in relation to the time slots. In each time slot, the transmitter power P_{S} is thus distributed between n overlapping chirp pulses at any point in time. If the symbol spacing is chosen, as in the time slot for channel measurement, to be so large that adjacent chirp pulses no longer overlap (in this case Δt>T), then a single chirp pulse, i.e. a single transmitted time-spread symbol, will be transmitted with the total transmitter power of the slot, for example with the maximum transmitter power, as shown in the diagram for slot 0.

FIG. 9.10a shows the distribution of the channel resources of a TDMA system known from FIG. 9.9. The signal received by time compression in the receiver is shown schematically in the diagram represented in FIG. 9.10b.

It can be seen that the peak amplitude U_{S0out} of the time-compressed (despread) signal for slot 0 (P_{S0}−Pₘₐₓ, n₀=1) is the highest. Transmission took place in the adjacent slot 1 with the same transmitter power (P_{S1}=Pₘₐₓ). The achieved peak amplitude U_{S1out} of the compressed pulses is significantly less. A symbol spacing of Δt₀≧T is achieved in time slot 0 [T_{S0}], a higher symbol rate is provided for time slot 1 [T_{S1}] and the symbol spacing □t₁ is correspondingly less. The lower part of the diagram shows how the achievable system gain is calculated for the individual time slots. The symbols in the time slot for the channel measurement are transmitted with a very low symbol rate but on the other hand with the maximum possible system gain G₀=BT. If the symbol rate is increased while maintaining the chirp duration T, then the system gain reduces to a value G=1, shown in the example for time slot m [T_{Sm}]. In this, the symbol rate D has reached its maximum and adjacent symbols have the spacing δ. In this case the symbol rate D is equal to the effective bandwidth B; frequency spreading does not take place (limiting case for the highest possible data rate).

A maximum transmitter power has been assumed for slots 0, 1 and m (P_{S0}=P_{S1}=P_{Sm}=Pₘₐₓ). In the example of slots 2, 3, 4, . . . , it is shown in the slot diagram that the transmitter power can also take values less than Pₘₐₓ. Three degrees of freedom therefore exist in the organisation of the subscriber accesses—the length of the time slot, the symbol rate within the individual time slots and the transmitter power provided for the individual slots.

If slot 3, for instance, is considered, then it is clear that transmission is carried out with a very low transmitter power P_{S3} and with the maximum possible symbol rate 1/δ. As a rule, this combination will only be possible when the distance to be overcome by the transmitted signal for a given noise power-density is low. The other extreme case—maximum transmitter power at very low symbol rate—is demonstrated by the interval for channel measurement (slot 0). For measuring purposes it is required that the two pulses are transmitted with special safeguarding against noise interference, i.e. with increased S/N. For this purpose, the maximum system-immanent spreading gain Gₘₐₓ=BT is activated for the transmission of every single measuring symbol and, in addition, the transmitter power Pₓₘᵢₜis maximised (Pₓₘᵢₜ=Pₘₐₓ)

Between these two extremes, the slot data of the TDMA frame must be matched to variable subscriber requirements and transmission conditions. In doing so a further aspect must be taken into account. As a rule, the transmission is subject to interference from multipath effects. This means that message symbols within a time slot are distorted by multiple reflections and can cause inter-symbol interference both in their own time slot and in following time slots. In order to keep the interference power so caused as low as possible in the following time slots (with respect to the transmitter power P_{S} set there), it is advantageous to sort the individual traffic time slots within the TDMA frame according to increasing power. Example: P_{S2}<P_{S3}<P_{S4}< . . . <P_{Sm}.

Also shown in FIG. 9.10 are the formulae for determining the system gain G and the peak amplitude Uₛ₁_{_{—}}ₒᵤₜ of the signal compressed at the receiver end for the individual time slots.

The peak amplitudes to be expected of the signals compressed in at the receiver end time slots 0, 1, . . . , m for a slot distribution according to FIG. 9.10 are calculated in FIG. 9.11.

FIG. 9.12 gives an example of changing the slot data when the system requirements change. The reference for this is FIG. 9.10. The slot widths for slots S₂, S₃ and S₄ and the assigned transmitter power for slot 3 have changed.

The peak amplitudes to be expected of the signals compressed at the receiver end in time slots 0, 1, . . . , m for a changed slot distribution according to FIG. 9.12 are calculated in FIG. 9.13.

FIG. 9.14 shows the form of the ends of the envelope of the transmission signal for the TDMA slot regime known from FIG. 9.9. If single non-overlapping chirp pulses are transmitted, as in the measuring interval T_{S0}, then the rise and decay times are dependent on the bandwidth of the transmitter. If overlapping chirp pulses are transmitted, then the edges have a flatter appearance. In this case, the rise and decay times are additionally dependent on the number n of overlapping pulses.

The diagram in the bottom part of the picture clarifies this effect. Highlighted in an extract are the decay of the second chirp pulse in the measuring interval T_{S0} and the shape of the rising edge in the synchronisation interval T_{S1}.

At the same time this shows the mechanism of time-spreading when passing through a dispersive filter. This time-spreading can be interpreted as if each symbol had been converted into a chirp pulse of length T. The sequence of symbols in the time-spread signal then appears as a sequence of chirp pulses with the same characteristics, which are produced offset to one another by a symbol spacing Δt and are additively superimposed. The rising edge only reaches its final position after a time period of n·Δt. (This representation is highly simplified. If a bipolar sequence of sin(x)/x pulses is transmitted, then, in reality, chirp pulses, offset in time with statistically distributed reversal of polarity, are superimposed upon one another). Fundamentally however, the shape of the edges of the ends of the envelope can be explained with this model.

Principle aspects of the present invention and its particular advantages can be summarised as follows:

The transmission method according to the present invention or the multiple-access system according to the invention works using frequency- and time-spread signals, and the method according to the invention enables operation with subscriber-related different and variable symbol rates.

Each subscriber is assigned the full channel bandwidth B regardless of the required symbol rate R. If frequency reserves exist, i.e. if the channel bandwidth is greater than the symbol rate R, then these frequency reserves are converted automatically and directly into a system gain by frequency-spread transmission. The methods for frequency- and time-spreading can be implemented solely on the physical plane. In this way it is possible to control the system gain by a simple change of the data rate without changing other system characteristics (re-initialising or similar).

The frequency-spreading method (symbol-by-symbol quasi Dirac pulse formation with subsequent matching filtering) guarantees that each message symbol is spread to the full channel bandwidth. The subsequent time-spreading (conversion of the frequency-spread symbols in the transmitter into chirp pulses) is easily achieved by passing the sequence of frequency-spread symbols through a dispersive filter with a suitable frequency/run-time characteristic (for example a SAW chirp filter).

Re-converting the chirp signals at the receiver end takes place with a further chirp filter whose frequency/run-time characteristic is the inverse of that of the chirp filter at the sending end.

The inverted frequency/run-time characteristic described between the sending and receiving chirp filters is the only condition which is necessary for reconversion. If chirp filters with this characteristic are designed as passive components (for example in SAW technology (SAW=Surface Acoustic Wave)), then reconversion of the chirp signals and, by suitable choice of the modulation process, also the demodulation of the signals received, can take place fully asynchronously.

Full utilisation of channel bandwidth for transmitting each individual symbol predetermines the transmitting pulses (time-spread signals) even for the channel assessment. If such a broadband symbol (chirp pulse) is transmitted, it excites the channel with the same intensity over the whole of its bandwidth. In the receiver, the chirp filter undertakes the transformation from the frequency domain to the time domain so that the pulse response of the channel appears directly at the filter output. Associated with symbol-by-symbol time-spreading is a suppression of interference, which is superimposed on the message signal in the transmission link. The despreading (compression) at the receiver end of the symbols received at the same time causes a spreading (expansion) of the superimposed interference signals. As a result of this process, the interference energy is distributed over a longer period of time and the probability of the information symbols being destroyed reduces.

In the transmission method according to the invention, a single symbol (chirp pulse) is sufficient to determine precisely the complete channel pulse response.

This does not rule out that this accuracy can be further increased by transmitting several consecutive reference symbols with a spacing corresponding to the maximum delay spread and forming the mean value or by auto-correlation.

The transmission method according to the invention provides a measure of flexibility and functionality right at the physical level which can only be realised by other known systems (CDMA, TDMA, FDMA) at higher levels of signal-processing by means of computer operations.

To halve the transmission data rate for example, in the described transmission method according to the invention, the time-related spacing between two consecutive symbols and the energy of the individual symbol are doubled. In this way, the channel resources are fully utilised even at half the data rate. To achieve the same effect, other systems would have to include redundancy in the data stream (for example by interleaving). As a result, the data rate visible to the user for an unchanged physical symbol rate is halved.

1. In a transmission system comprising a transmitter and a receiver, a method of transmitting information symbols having a symbol rate (R) via a channel having a bandwidth (B), the method comprising:
defining transmission quality and channel characteristics;
in the transmitter, frequency spreading and time spreading the information symbols, and thereafter transmitting an information symbol signal;
upon receiving the transmitted information symbol signal in the receiver, adaptively de-spreading the information symbols and controlling transmission system gain in relation to the transmission quality and channel characteristics.

2. The method of claim 1, wherein transmission system gain is controlled by varying symbol rate (R).

3. The method of claim 1, further comprising the step of:
adjusting the frequency spread of the information symbols in relation to at least one parameter selected from a group of parameters consisting of transmitter power, bit error rate, and transmission speed.

4. The method of claim 3, further comprising the step of:
adjusting the time spread of the information symbols in relation to at least one parameter selected from a group of parameters consisting of transmitter power, bit error rate, and transmission speed.

5. The method of claim 4, wherein frequency spreading of the information symbols comprises:
forming quasi Dirac pulses and filtering the quasi Dirac pulses, such that each information symbols is fully spread across channel bandwidth (B); and,
wherein time spreading of the information symbols comprises:
interleaving one or more information signals with a correlation signal.

6. The method of claim 5, wherein the correlation signal is a chirp pulse signal.

7. The method of claim 4, wherein at least one of transmitter power, bit error rate, and transmission speed is individually matched to a transmission system subscriber.

8. The method of claim 5, further comprising:
assessing channel characteristics using the transmitted information symbol signal.

9. The method of claim 8, further comprising:
reducing symbol rate (R) in relation to a constant channel bandwidth as determined by a channel characteristic assessment.

10. The method of claim 9, wherein frequency spreading of the information symbols further comprises:
forming a quasi Dirac pulse sequence in a first transmitter stage for each information symbol, regardless of the symbol rate; and,
band pass filtering the quasi Dirac pulse sequence in a second transmitter stage.

11. The method of claim 5, further comprising:
compresssing the information symbol signal in the receiver.

12. In a transmission system comprising a transmitter and a receiver, a method of transmitting information symbols via a channel having a bandwidth, the information symbols being transmitted in accordance with one or more transmission parameters selected from a group of parameters comprising transmission speed, bit error rate, and transmitter power, the method comprising:
determining a first priority transmission parameter;
assessing the channel transmission characteristics at the receiver;
communicating the assessed channel transmission characteristics to the transmitter before beginning transmission of the information symbols; and,
transmitting the information symbols while maintaining a predetermined value for at least the first priority transmission parameter.

13. The method of claim 12, further comprising:
where required in relation to the assessed channel transmission characteristics, adjusting transmission parameters other than the first transmission parameter in order to maintain the predetermined value of the first priority transmission parameter.

14. The method of claim 13, further comprising:
determining second and third priority transmission parameters.

15. The method of claim 14, further comprising:
determining for a particular transmission whether the transmission system will transmit voice or data.

16. The method of claim 15, further comprising:
upon determining that the transmission system will transmit voice, further determining that transmitter power is the first priority transmission parameter, transmission speed is the second priority transmission parameter, and bite error rate is the third priority transmission parameter; and,
upon determining that the transmission system will transmit data, further determining that bit error rate is the first priority transmission parameter, transmitter power is the second priority transmission parameter, and transmission speed is the third priority transmission parameter.

17. The method of claim 12, wherein information symbols are transmitted in a sequence of time slots, and wherein the method further comprises:
adjusting transmitter power on a time slot by time slot basis in relation to a determination of transmission system gain during each time slot.

18. The method of claim 17, further comprising:
defining within the transmission system an organization channel and a plurality of mutually independent message channels, each one of the plurality of message channels defining a corresponding sequence of time slots;
defining transmission frames, each frame having a frame length and comprising a sub-frame interval during which channel characteristics, including transmission system gain, are measured;
transmitting information symbols via a selected one of the plurality of message channels in relation to a transmission frame;
varying the time slots in the selected one message channel in accordance with measured channel characteristics; and,
varying transmitter power on a time slot by time slot basis in accordance with transmission system gain.

19. The method of claims 18 wherein individual transmission system subscriber time slots in a transmission frame are arranged in accordance with their assigned transmitter power.

20. The method according of claim 18, wherein transmitter power in any one time slot is distributed over a plurality of overlapping chirp pulses.

21. The method of claim 18, wherein information symbol spacing in a time slot for channel measurement is set to be so large that adjacent chirp pulses do not overlap.

22. The method of claim 19, further comprising:
for each transmission system subscriber, setting logic parameters for a given message channel, the logic parameters including at least length of time slots, symbol rate within individual time slots, and transmitter power provided during individual time slots, in accordance with measured channel characteristics and in relation to subscriber-specific requirements.

23. The method of claim 4, wherein time spreading in the transmitter is accomplished using a dispersive filter having a suitable frequency/run-time characteristic.

24. The method of claim 23, wherein the dispersive filter in the transmitter and a corresponding filter in the receiver used for time-compression are implemented in the form of surface wave filters (SAW filters).

25. The method of claim 23, wherein the dispersive filter in the transmitter and a corresponding filter in the receiver used for time-compression are implemented in the form of charge-coupled device filters (CCD filters).

26. The method of claim 8, wherein channel assessment is made in the receiver in relation to a channel pulse response arising from the transmission of a time-compressed reference symbols.

27. The method of claim 26, further comprising:
synchronizing a symbol clock in the receiver in accordance the transmitted reference symbols.

28. The method of claim 5, wherein the correlation signal comprises a signal having an auto-correlation characteristic fulfilling the first Nyquist criterion.

29. The method of claim 6, wherein the chirp pulse signal is weighted with an absolute frequency sequence of a root Nyquist filter.

30. The method of claim 5 wherein the correlation signal is one selected from a group of correlation signals having characteristics determined by conditions external to the transmission of the information symbols.

31. The method of claim 12, wherein the receiver comprises a Fractional Spaced Equalizer (FSE), and the method further comprises:
pre-emphasizing the information symbols at the transmitter following channel assessment at the receiver and communication of the assessed channel transmission characteristics to the transmitter.

32. The method of claim 26, further comprising:
using an iterative process, calculating the channel pulse response in parametric form using one or more reflection coefficients;
determining multipath echo from the channel pulse response and subtracting the echo from the signal received at an equalization stage in the receiver.
